(19) United States
(12) Patent Application Publication
(10) Pub. No.: US 2025/0386243 A1
(43) Pub. Date: Dec. 18, 2025

(54) SELECTIVE SERVICE DATA UNIT FORWARDING TECHNIQUES

(71) Applicant: QUALCOMM Incorporated, San Diego, CA (US)

(72) Inventors: Sherif ELAZZOUNI, San Diego, CA (US); Gavin Bernard HORN, La Jolla, CA (US); Ozcan OZTURK, San Diego, CA (US)

(21) Appl. No.: 18/745,585

(22) Filed: Jun. 17, 2024

(51) Int. Cl. H04W 28/06; H04L 41/5009; H04W 8/22

(52) U.S. Cl. CPC H04W 28/06; H04L 41/5009; H04W 8/22

(57) ABSTRACT

Methods, systems, and devices for wireless communications are described. A user equipment (UE) may deliver one or more service data units SDUs within a packet data convergence protocol (PDCP) window to an upper protocol layer before an expiration of a timer associated with the PDCP window. The UE may forward the one or more SDUs based on a forwarding rule, as part of a forwarding sub-window of the PDCP window, or both. The UE may deliver the portion of the set of SDUs based on one or more predictions of a machine learning (ML) model and/or functionality associated with SDUs of the PDCP window. In some examples, the UE may report information associated with the PDCP window to a network entity. The UE may receive one or more control messages indicating information associated with the PDCP window.

### FIELD OF TECHNOLOGY

The following relates to wireless communications, including selective service data unit forwarding techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support selective service data unit (SDU) forwarding techniques. For example, the described techniques provide for a user equipment (UE) to begin a timer based on a first SDU being absent from a packet data convergence protocol (PDCP) window, and to deliver (e.g., selectively deliver, selectively forward) a portion of a set of SDUs within the PDCP window to an upper protocol layer before an expiration of the timer. For example, the portion may include one or more SDUs of the set of SDUs, and the UE may forward the portion based on a forwarding rule, as part of a forwarding sub-window of the PDCP window (e.g., a sub-window that is relatively smaller than the PDCP window), or both. In some cases, the UE may determine to deliver the portion of the set of SDUs based on one or more predictions by an artificial intelligence (AI) and/or machine learning (ML) model and/or functionality, where the one or more predictions may be associated with one or more SDUs of the PDCP window. In some cases, the UE may report information associated with the PDCP window to a network entity. For example, the information may indicate SDUs that have been delivered to the upper layer, a reordering policy used by the UE for delivering the portion of the set of service data units to the upper layer, information associated with the set of service data units, or any combination thereof. Additionally, or alternatively, the UE may receive one or more control messages indicating information associated with the PDCP window. In some cases, the UE may also receive a control message indicating one or more key performance indicators (KPIs) associated with the PDCP reordering window, and may perform one or more actions if the UE fails to satisfy the one or more KPIs.

A method for wireless communications by a UE is described. The method may include receiving a control message that indicates one or more parameters associated with PDCP reordering, where the one or more parameters include one or more ranges associated with at least one parameter of the one or more parameters, one or more performance parameters, or any combination thereof, processing a set of SDUs via a PDCP reordering window associated with a PDCP layer of a protocol stack of the UE, starting a timer based on a count of the set of SDUs that indicates that at least one SDU is missing from the set of SDUs, and delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

A UE for wireless communications is described. The UE may include one or more memories storing processor executable code, and one or more processors coupled with the one or more memories. The one or more processors may individually or collectively be operable to execute the code to cause the UE to receive a control message that indicates one or more parameters associated with PDCP reordering, where the one or more parameters include one or more ranges associated with at least one parameter of the one or more parameters, one or more performance parameters, or any combination thereof, process a set of SDUs via a PDCP reordering window associated with a PDCP layer of a protocol stack of the UE, start a timer based on a count of the set of SDUs that indicates that at least one SDU is missing from the set of SDUs, and deliver, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

Another UE for wireless communications is described. The UE may include means for receiving a control message that indicates one or more parameters associated with PDCP reordering, where the one or more parameters include one or more ranges associated with at least one parameter of the one or more parameters, one or more performance parameters, or any combination thereof, means for processing a set of SDUs via a PDCP reordering window associated with a PDCP layer of a protocol stack of the UE, means for starting a timer based on a count of the set of SDUs that indicates that at least one SDU is missing from the set of SDUs, and means for delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

A non-transitory computer-readable medium storing code for wireless communications is described. The code may include instructions executable by one or more processors to receive a control message that indicates one or more parameters associated with PDCP reordering, where the one or more parameters include one or more ranges associated with at least one parameter of the one or more parameters, one or more performance parameters, or any combination thereof, process a set of SDUs via a PDCP reordering window associated with a PDCP layer of a protocol stack of the UE, start a timer based on a count of the set of SDUs that indicates that at least one SDU is missing from the set of SDUs, and deliver, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

Some examples of the method, UEs, and non-transitory computer-readable medium described herein may further include operations, features, means, or instructions for determining, based on one or more predictions associated with the set of SDUs, whether to deliver the one or more SDUs out-of-order with respect to other SDUs of the set of SDUs in accordance with the forwarding rule, where the one or more SDUs may be delivered to the upper layer in accordance with the determination.

In some examples of the method, UEs, and non-transitory computer-readable medium described herein, the one or more predictions include a prediction of respective flows associated with each service data unit of the set of service data units, and delivering the portion may include operations, features, means, or instructions for delivering the one or more SDUs based on the prediction that indicates that the one or more SDUs may be associated with a same flow.

In some examples of the method, UEs, and non-transitory computer-readable medium described herein, the one or more predictions include a prediction of one or more attributes associated with each service data unit of the set of service data units, and delivering the portion may include operations, features, means, or instructions for delivering the one or more SDUs based on the prediction that indicates that the one or more SDUs may be associated with a first attribute of the one or more attributes to forward the one or more SDUs to the upper layer before the timer expires, a second attribute to reorder the set of SDUs, or both.

In some examples of the method, UEs, and non-transitory computer-readable medium described herein, the one or more attributes include a transport control protocol acknowledgment, a packet delay budget parameter, a latency parameter, a correspondence to one or more previously-delivered SDUs, a correspondence to a quality of service flow, one or more application parameters, or any combination thereof.

In some examples of the method, UEs, and non-transitory computer-readable medium described herein, the one or more predictions include a prediction of a priority associated with each service data unit of the set of service data units, and delivering the portion may include operations, features, means, or instructions for delivering the one or more SDUs based on the prediction that indicates that a priority of the one or more SDUs indicates that the one or more SDUs may be forwarded to the upper layer before the timer expires.

Some examples of the method, UEs, and non-transitory computer-readable medium described herein may further include operations, features, means, or instructions for determining a size of the forwarding sub-window based on a prediction of the at least one SDU missing from the set of SDUs and one or more SDUs that may have not yet been included in the PDCP reordering window, where the one or more SDUs may be delivered to the upper layer based on the size of the forwarding sub-window.

In some examples of the method, UEs, and non-transitory computer-readable medium described herein, the timer continues to run after the one or more SDUs may be delivered to the upper layer before the timer expires in accordance with the forwarding sub-window.

Some examples of the method, UEs, and non-transitory computer-readable medium described herein may further include operations, features, means, or instructions for determining that the size of the forwarding sub-window may be at least equal to a size of the PDCP reordering window, delivering the set of SDUs associated with the PDCP reordering window, and stopping the timer.

In some examples of the method, UEs, and non-transitory computer-readable medium described herein, the portion of the set of SDUs that may be delivered include one or more received and buffered SDUs.

Some examples of the method, UEs, and non-transitory computer-readable medium described herein may further include operations, features, means, or instructions for identifying one or more features associated with a ML model used for predictions of the one or more SDUs to be delivered to the upper layer in accordance with the forwarding rule, as part of the forwarding sub-window of the PDCP reordering window, or both, the one or more features including flow detection, PDU set detection, packet type detection, latency sensitivity detection, priority detection, detection of a correspondence between respective SDUs, arrival latency detection, predicted failure detection, or any combination thereof, where the portion of the set of SDUs may be delivered based on the one or more features, and predicting, using the machine learning model and based at least in part on the one or more features, the one or more service data units to be delivered to the upper layer in accordance with the forwarding rule, as part of the forwarding sub-window of the PDCP reordering window, or both.

Some examples of the method, UEs, and non-transitory computer-readable medium described herein may further include operations, features, means, or instructions for transmitting a message including information that indicates SDUs that may have been delivered to the upper layer, the information including an indication of SDUs that were delivered in order, an indication of SDUs delivered out-of-order based on an expiration of the timer, an indication of SDUs delivered out-of-order in accordance with the forwarding rule, an indication of SDUs delivered out-of-order as part of the forwarding sub-window of the PDCP reordering window, or any combination thereof.

Some examples of the method, UEs, and non-transitory computer-readable medium described herein may further include operations, features, means, or instructions for transmitting a message including an indication of a reordering policy used by the UE to deliver the portion of the set of SDUs to the upper layer, the reordering policy indicates one or more second parameters used for the one or more SDUs delivered out-of-order with respect to other SDUs of the set of SDUs.

Some examples of the method, UEs, and non-transitory computer-readable medium described herein may further include operations, features, means, or instructions for transmitting a message that indicates information associated with the set of SDUs, where the information includes an indication of a predicted arrival time of the one or more SDUs, an indication of the one or more SDUs that may be forwarded out-of-order with respect to other SDUs of the set of SDUs, an indication of the set of SDUs that may be delivered in-order, an indication of a value of the timer when the portion may be delivered to the upper layer, an indication of a value of the count when the portion may be delivered to the upper layer, an indication of respective index values of the set of SDUs, an indication of a difference between a predicted arrival time of a first SDU of the set of SDUs and an actual arrival time of the first SDU, an indication of a frequency of satisfying one or more KPIs, or any combination thereof.

Some examples of the method, UEs, and non-transitory computer-readable medium described herein may further include operations, features, means, or instructions for transmitting a capability message that indicates a capability of the UE to support delivery of the portion of the set of SDUs, an accuracy of a ML model with respect to one or more predictions, or both, where the one or more predictions include one or more predicted attributes of a buffered SDU, one or more predicted attributes of a SDU that may have not yet arrived, a predicted arrival time of respective SDUs of the set of SDUs, or any combination thereof.

Some examples of the method, UEs, and non-transitory computer-readable medium described herein may further include operations, features, means, or instructions for receiving a second control message that indicates a configuration of one or more reordering parameters used to reorder the set of SDUs, or to deliver the portion of the set of SDUs in accordance with the forwarding rule, or both, where the one or more SDUs may be delivered in accordance with the forwarding rule may be based on the configuration.

In some examples of the method, UEs, and non-transitory computer-readable medium described herein, the one or more reordering parameters include a first threshold duration of the timer before the one or more SDUs may be delivered, a second threshold duration of the timer to deliver the one or more SDUs, a set of attributes used to forward the one or more SDUs, a threshold quantity of SDUs that may be allowed to be forwarded before the timer expires, a threshold quantity of SDUs per set of attributes that may be allowed to be delivered out-of-order with respect to other SDUs, a second timer associated with a duration, an indication of whether use of a ML model may be allowed to deliver the set of SDUs, an indication of whether the one or more SDUs may be delivered in accordance with the forwarding rule, or any combination thereof.

Some examples of the method, UEs, and non-transitory computer-readable medium described herein may further include operations, features, means, or instructions for receiving a control message that indicates a configuration of one or more reordering parameters, where the one or more reordering parameters may be used to deliver the portion of the set of SDUs as part of the forwarding sub-window of the PDCP reordering window, and where the one or more SDUs may be delivered as part of the forwarding sub-window of the PDCP reordering window based on the configuration.

In some examples of the method, UEs, and non-transitory computer-readable medium described herein, the one or more reordering parameters include a threshold duration of the timer before delivering the one or more SDUs, a threshold quantity of SDUs that may be allowed to be forwarded before the timer expires, a second timer associated with a duration, an indication of whether delivery using the forwarding sub-window may be allowed, or any combination thereof.

Some examples of the method, UEs, and non-transitory computer-readable medium described herein may further include operations, features, means, or instructions for receiving a control message including an indication of one or more KPIs associated with the PDCP reordering window, where the portion of the set of SDUs may be delivered based on the one or more KPIs.

Some examples of the method, UEs, and non-transitory computer-readable medium described herein may further include operations, features, means, or instructions for determining that the one or more KPIs fail to be satisfied based on delivery of the portion of the set of SDUs and delivering, from the PDCP layer to the upper layer of the protocol stack, a second set of SDUs based on an expiration of the timer and a failure to satisfy the one or more KPIs.

Some examples of the method, UEs, and non-transitory computer-readable medium described herein may further include operations, features, means, or instructions for determining that the one or more KPIs fail to be satisfied based on delivery of the portion of the set of SDUs and transmitting a report message including an indication that the one or more KPIs fail to be satisfied.

### BRIEF DESCRIPTION OF THE DRAWINGS

FIG. 1 shows an example of a wireless communications system that supports selective service data unit (SDU) forwarding techniques in accordance with one or more aspects of the present disclosure.

FIG. 2 shows an example of a wireless communications system that supports selective SDU forwarding techniques in accordance with one or more aspects of the present disclosure.

FIGS. 3 and 4 show examples of SDU forwarding diagrams that support selective SDU forwarding techniques in accordance with one or more aspects of the present disclosure.

FIG. 5 shows an example of a process flow that supports selective SDU forwarding techniques in accordance with one or more aspects of the present disclosure.

FIG. 6 shows an example of a machine learning (ML) architecture that supports selective SDU forwarding techniques in accordance with one or more aspects of the present disclosure.

FIGS. 7 and 8 show examples of block diagrams of a user equipment (UE) that support selective SDU forwarding techniques in accordance with one or more aspects of the present disclosure.

FIGS. 9 through 15 show examples of process flows that support selective SDU forwarding techniques in accordance with one or more aspects of the present disclosure.

FIG. 16 shows an illustrative block diagram of an example ML architecture that may be used for wireless communications in accordance with one or more aspects of the present disclosure.

FIGS. 17 and 18 show block diagrams of devices that support selective SDU forwarding techniques in accordance with one or more aspects of the present disclosure.

FIG. 19 shows a block diagram of a communications manager that supports selective SDU forwarding techniques in accordance with one or more aspects of the present disclosure.

FIG. 20 shows a diagram of a system including a device that supports selective SDU forwarding techniques in accordance with one or more aspects of the present disclosure.

FIG. 21 shows a flowchart illustrating methods that support selective SDU forwarding techniques in accordance with one or more aspects of the present disclosure.

### DETAILED DESCRIPTION

In some wireless communications systems, a user equipment (UE) may receive signaling from another device (e.g., physical layer signaling, a physical signal, downlink, sidelink) that indicates (e.g., includes) a physical layer packet. Beginning at the physical layer of a protocol layer stack of the UE, the UE may process the physical layer packet through one or more additional protocol layers including a packet data convergence protocol (PDCP) layer (e.g., PDCP protocol layer). At the PDCP layer, the UE may process one or more PDCP service data units (SDUs) from the signaling based on a PDCP window (e.g., PDCP reordering windows). For example, the PDCP window may include a queue of a set of service data units (SDUs) (e.g., from the physical layer packet) ordered according to a count (e.g., a count order, a buffer order, an SDU order). The PDCP window may be referred to as a PDCP reordering window and may define a range (e.g., a quantity) of sequence numbers associated with SDUs that the UE may reorder within a duration of time, where the range of sequence numbers may be less than or equal to a total quantity of possible sequence numbers. In particular, the PDCP window may be used by the UE to process received SDUs (or received packet data units (PDUs)), including cases where the respective sequence numbers of the received SDUs (or PDUs) are not consecutive. As such, the PDCP window may be used to determine whether an SDU or PDU received by a PDCP entity is a new SDU (or now PDU) or an out-of-order SDU (or out-of-order PDU). In some aspects the PDCP window may have a configured size that is associated with a determination of whether to increment a count of received SDUs or PDUs. In some cases, the UE may use the count to sequentially determine if each SDU of the set of SDUs in the PDCP window is received at the PDCP layer (e.g., correctly decoded through other protocol layers and forwarded to the PDCP layer), and deliver (e.g., forward) the set of SDUs to an upper layer based on determining that each SDU of the set is received at the PDCP layer.

In some cases, the UE may determine that one or more SDUs are missing from the PDCP window (e.g., absent, not received), which may create a gap (e.g., hole) in the PDCP window. Accordingly, the UE may perform SDU reordering procedures, which may include starting a timer (e.g., a t-reordering timer) associated with the PDCP window based on the missing SDU, and pausing further processing of the SDUs for the duration of the timer. If the missing SDU is received at the PDCP layer before an expiration of the timer, the UE may forward the set of SDUs to the upper layer (e.g., after determining that the other SDUs of the PDCP window are received). Alternatively, if the missing SDU is not received before an expiration of the timer, the UE may forward the set of SDUs of the PDCP window to the upper layer to avoid further latency in waiting for the missing SDU. Either way, a forwarding granularity of the UE (e.g., the smallest quantity of information that the UE may forward to the upper layer at one time) may be the PDCP window (e.g., all the SDUs of the PDCP window). However, using such a forwarding granularity may cause SDUs of the PDCP window that are already received (e.g., of a count higher than that of the missing SDU) to wait for the expiration of the timer (e.g., increasing latency). Further, the missing SDU may be lost (e.g., not received as part of the physical signal or lost in a lower protocol layer), which may cause the UE to wait for the expiration of the timer and still not receive the missing SDU. Thus, a method of managing SDUs at the PDCP layer with reduced latency may be beneficial.

According to techniques described herein, a UE may begin a timer based on a first SDU being absent from a PDCP window, and may deliver (e.g., selectively deliver, selectively forward) a portion of a set of SDUs within the PDCP window to an upper protocol layer before an expiration of the timer. For example, the portion may include one or more SDUs of the set of SDUs, and the UE may forward the portion based on a forwarding rule, as part of a forwarding sub-window (e.g., the sub-window being smaller than the PDCP window) of the PDCP window, or both. Thus, the UE may reduce the forwarding granularity of the PDCP layer, and may reduce latency associated with the timer and the PDCP layer.

In some cases, the UE may determine to deliver the portion of the set of SDUs based on one or more predictions of one or more artificial intelligence (AI) and/or machine learning (ML) models and/or functionalities (e.g., which may be referred to herein as an ML model and/or functionality, which may include AI, ML, or other algorithms). In some cases, the one or more predictions may be associated with one or more SDUs of the PDCP window. For example, the one or more predictions may include respective flows associated with each SDU of the set of SDUs, one or more attributes associated with each SDU of the set of SDUs, a priority associated with each SDU of the set of SDUs, or a combination thereof.

In some cases, the UE may report information associated with the PDCP window to a network entity. For example, the information may indicate SDUs that have been delivered to the upper layer. Additionally, or alternatively, the information may indicate a reordering policy used by the UE for delivering the portion of the set of service data units to the upper layer, information associated with the set of service data units, or both. In some cases, the UE may also transmit one or more capability messages to the network entity, indicating a capability of the UE to use the ML model and/or functionality for selective SDU forwarding, an accuracy of an ML model and/or functionality for selective SDU forwarding, or both.

Additionally, or alternatively, the UE may receive one or more control messages indicating information associated with the PDCP window. For example, the UE may receive a control message indicating one or more reordering parameters associated with reordering the set of SDUs, delivering the portion of the set of SDUs in accordance with the forwarding rule, delivering the portion of the set of service data units as part of the forwarding sub-window, or any combination thereof. In some cases, the UE may also receive a control message indicating one or more key performance indicators (KPIs) associated with the PDCP reordering window, and may perform one or more actions if the UE fails to satisfy the one or more KPIs.

Aspects of the disclosure are initially described in the context of wireless communications systems. Aspects of the disclosure are also described in the context of SDU forwarding diagrams and process flows. Aspects of the disclosure are further illustrated by and described with reference to apparatus diagrams, system diagrams, and flowcharts that relate to selective SDU forwarding techniques. As used herein, the terms “deliver” and “forward” (e.g., selectively forward) may be used interchangeably. Additionally, or alternatively, the term “ML model,” as used herein, may refer to any algorithm that produces outputs (e.g., predictions) based on one or more received inputs, including an ML, an AI, a neural network, or any other algorithm. In some cases, the term “selectively,” as used herein (e.g., selectively forwarding, selectively delivering) may describe an action that is taken at least in part by selecting one or more items of a set (e.g., one or more SDUs of a set of SDU) on which the action is taken.

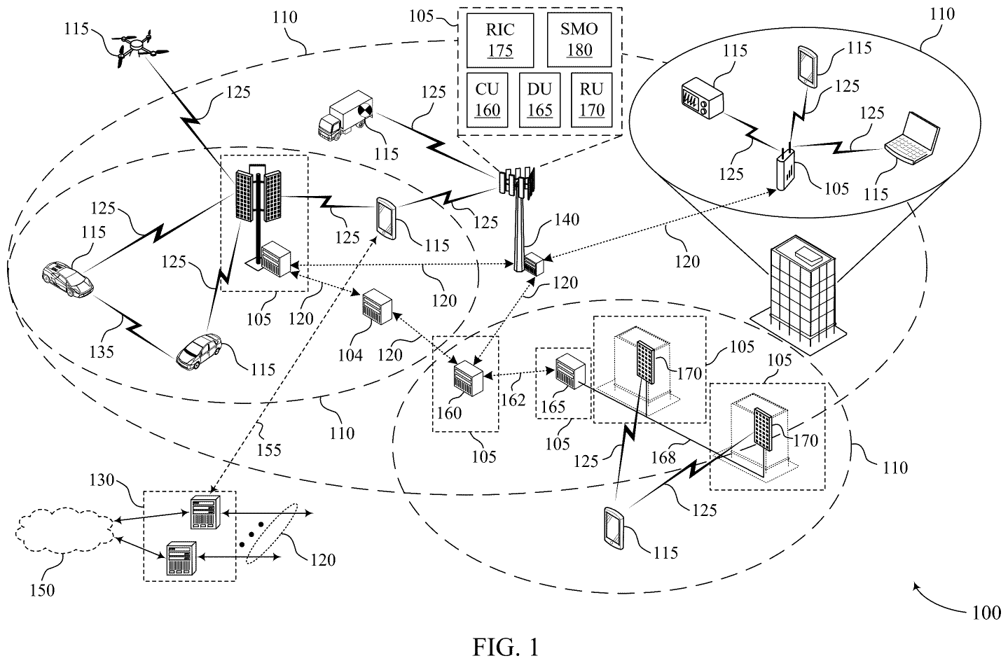

FIG. 1 shows an example of a wireless communications system 100 that supports selective SDU forwarding techniques in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. a CU 160 associated with a network entity 105 or base station 140 (such as a donor network entity or a donor base station) may partially control a DU 165, an RU 170, or both. The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to and/or referred to as ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some UEs 115 may support reordering of SDUs in the PDCP layer. For example, when transmitting a physical signal including a physical packet, the PDCP layer of the UE 115 may process one or more SDUs into other packaging (e.g., PDUs) for the physical packet. Processing the SDUs for transmission may include initiating a discard timer for each SDU in a PDCP window, and dropping (e.g., transmitting, canceling, deleting) an SDU from the PDCP window when the UE 115 either receives a PDCP status report for the SDU, or the discard timer expires.

When the UE 115 receives a physical signal including a physical packet, the PDCP layer of the UE 115 may process SDUs from the physical packet within a PDCP window (e.g., a PDCP reordering window), where the SDUs may be ordered within the PDCP window according to a count (e.g., a buffering order). Processing the SDUs in the PDCP window may include performing t-reordering, as described herein. In some cases, the UE 115 may utilize one or more variables for performing t-reordering. For example, RX_DELIV may refer to a state variable indicating a count value of a first SDU of the PDCP window that has not been delivered to other (e.g., upper) protocol layers, but is missing (e.g., not yet received, absent) from the PDCP window. An initial value for RX_DELIV may be 0. Additionally, RX_REORD may refer to a state variable indicating a second count value following (e.g., immediately subsequent to) a first count value associated with a packet (e.g., PDCP data PDU) which triggered a timer (e.g., a t-reordering timer) associated with the PDCP window. In some cases, the timer may be used to detect a missing PDCP data PDU, SDU, or both. If the timer is running, then the UE 115 may not start another instance of the timer. That is, in some conventional systems, if a first timer is active then the UE 115 may not support starting a second timer during the duration of the first timer (e.g., before expiration of the first timer). Additionally, RX_NEXT may refer to a state variable indicating a count value of a next SDU expected to be received in the sequence of packets. An initial value of RX_NEXT may be 0.

In processing the SDUs of a received physical packet, the UE 115 may initiate the timer when a PDCP gap (e.g., an SDU missing from the PDCP window) is detected at a count (e.g., at an SDU count index, one count index previous to RX_REORD). The UE 115 may stop the timer when each SDU within the PDCP window with a count (e.g., count index, according to a count order) less than RX_REORD is received at the PDCP layer. In some cases, the UE 115 may have previously forwarded each SDU with a count index less than RX_DELIV, and the UE 115 may buffer each SDU with a count index greater than RX_DELIV that is received at the PDCP layer into the PDCP window. If the timer expires, the UE 115 may forward SDUs with count indexes from RX_DELIV to RX_REORD (e.g., all the SDUs in the PDCP window, including at least one missing SDU). Additionally, the UE 115 may set RX_REORD to the value of RX_NEXT, and the UE 115 may set the value of RX_DELIV to the count index of a next missing SDU. If the UE 115 detects another PDCP gap, the UE 115 may restart the timer and repeat the process.

Thus, in t-reordering, the forwarding granularity (e.g., the smallest quantity of information that may be forwarded to the upper layer at one time) of the UE may be the PDCP window (e.g., all the SDUs of the PDCP window). That is, the UE may not have the capability to perform selective out-of-order processing of the SDUs in the PDCP window, nor the ability to partially control the PDCP window. For example, using conventional techniques, the UE may not be capable of partially forwarding the PDCP window (e.g., delivery a portion of the PDCP window) based on factors associated with each SDU of the PDCP window, including a sequence numbers (SN), a quality of service (QOS) flow, a predicted SDU priority (e.g., importance), or any combination thereof. Accordingly, SDUs of the PDCP window that are already received (e.g., of a count higher than that of the missing SDU) may wait for the expiration of the timer. Further, the missing SDU for which the UE started the timer may be lost (e.g., not received as part of the physical signal or lost in a lower protocol layer), causing the UE to wait for the expiration of the timer and not receive the missing SDU. Thus, a method of managing SDUs at the PDCP layer with less latency may be beneficial.

Wireless communications system 100 may support techniques for dynamically and selectively forwarding SDUs, for example, based on considerations of the flow and/or priority associated with the SDU. For example, a UE 115 may begin a timer (e.g., the t-reordering timer) associated with a PDCP window based on a first SDU being absent from the PDCP window, and the UE 115 may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115 may forward the portion based on a forwarding rule, as part of a forwarding sub-window (e.g., the sub-window being smaller than the PDCP window) of the PDCP window, or both. Thus, the UE 115 may reduce the forwarding granularity of the PDCP layer, and the UE 115 may reduce latency associated with the timer and the PDCP layer.

In some cases, the UE 115 may determine to deliver the portion of the set of SDUs based on one or more predictions of an ML model. In some cases, the one or more predictions may be associated with one or more SDUs of the PDCP window. For example, the one or more predictions may include respective flows associated with each SDU of the set of SDUs, one or more attributes associated with each SDU of the set of SDUs, a priority associated with each SDU of the set of SDUs, or a combination thereof.

In some cases, the UE 115 may report information associated with the PDCP window to a network entity 105. For example, the information may indicate SDUs that have been delivered to the upper layer. Additionally, or alternatively, the information may indicate a reordering policy used by the UE 115 for delivering the portion of the set of service data units to the upper layer, information associated with the set of service data units, or both. In some cases, the UE 115 may also transmit one or more capability messages to the network entity 105, indicating a capability of the UE 115 to use the ML model for selective SDU forwarding, an accuracy of an ML model for selective SDU forwarding, or both.

Additionally, or alternatively, the UE 115 may receive one or more control messages indicating information associated with the PDCP window. For example, the UE 115 may receive a control message indicating one or more reordering parameters associated with reordering the set of SDUs, delivering the portion of the set of SDUs in accordance with the forwarding rule, delivering the portion of the set of service data units as part of the forwarding sub-window, or any combination thereof. In some cases, the UE 115 may also receive a control message indicating one or more KPIs associated with the PDCP reordering window, and may perform one or more actions if the UE 115 fails to satisfy the one or more KPIs.

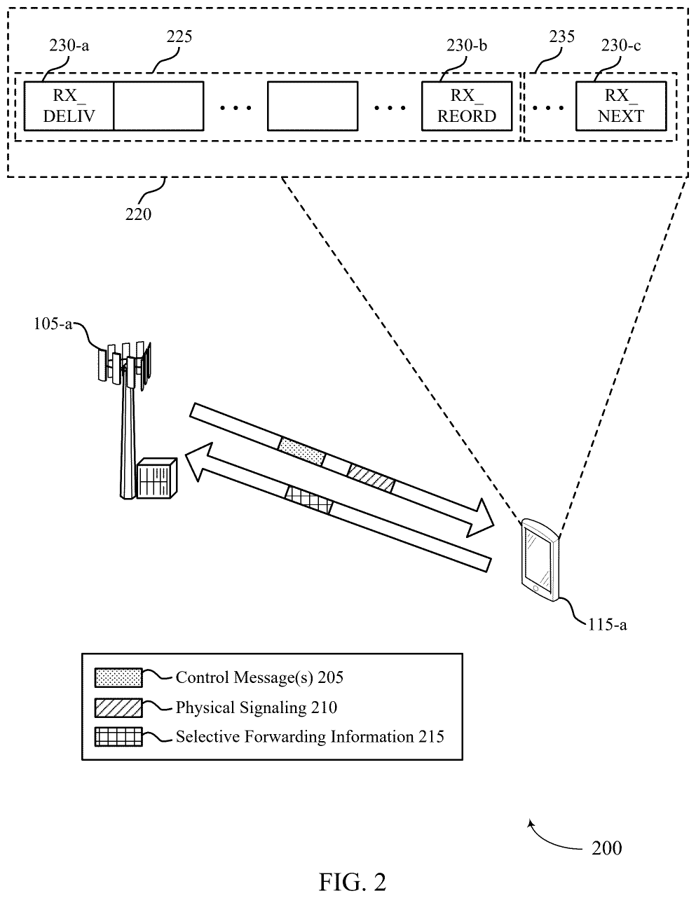

FIG. 2 shows an example of a wireless communications system 200 that supports selective SDU forwarding techniques in accordance with one or more aspects of the present disclosure. In some cases, aspects of the wireless communications system 200 may implement or be implemented by aspects of FIG. 1. For example, the wireless communications system 200 may include a UE 115-a and a network entity 105-a, which may be examples of the UEs 115 and the network entities 105, respectively, as described herein with respect to FIG. 1. In some cases, the UE 115-a may forward a portion of a PDCP window 225 from a PDCP layer 220 prior to an expiration of a timer associated with the PDCP window 225 (e.g., as described herein with respect to FIG. 1) based on a control message 205 carrying one or more parameters for PDCP reordering, PDCP forwarding, or both.

In the wireless communications system 200, the UE 115-a may receive physical signaling 210 (e.g., from the network entity, from another UE), and may process one or more SDUs 230 from the physical signaling 210 in the PDCP layer 220 of the UE 115-a. For example, the UE 115-a may use a PDCP window 225 (e.g., PDCP reordering window, PDCP processing window) to process a set of SDUs 230 within the PDCP layer 220. The PDCP window 225 may span from an SDU 230-a (e.g., with a count index equal to the state variable RX_DELIV) to an SDU 230-b (e.g., with a count index currently held in the state variable RX_REORD). Additionally, the PDCP layer may include one or more additional SDUs 230 (e.g., including an SDU 230-c with a count index currently held in the state variable RX_NEXT) in a buffer 235.

The UE 115-a and the network entity 105-a may exchange signaling, and the UE 115-a may deliver a portion of the PDCP window 225 to an upper layer based on the signaling. For example, the UE may receive one or more control messages (e.g., control messages 205) from the network entity, where the control messages 205 may include one or more parameters (e.g., parameters, reordering parameters, KPIs) associated with delivering the portion of the PDCP window 225. The UE 115-a may transmit selective forwarding information 215 to the network entity 105-a (e.g., within one or more fields of an uplink signal), where the selective forwarding information 215 may include indications associated with one or more SDUs 230 of the PDCP window 225.

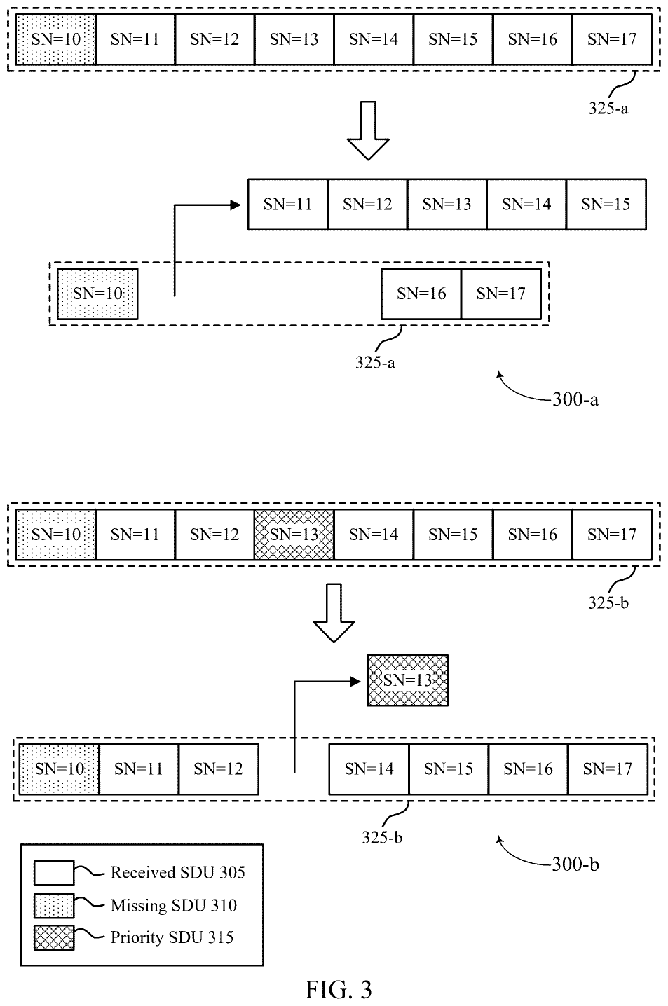

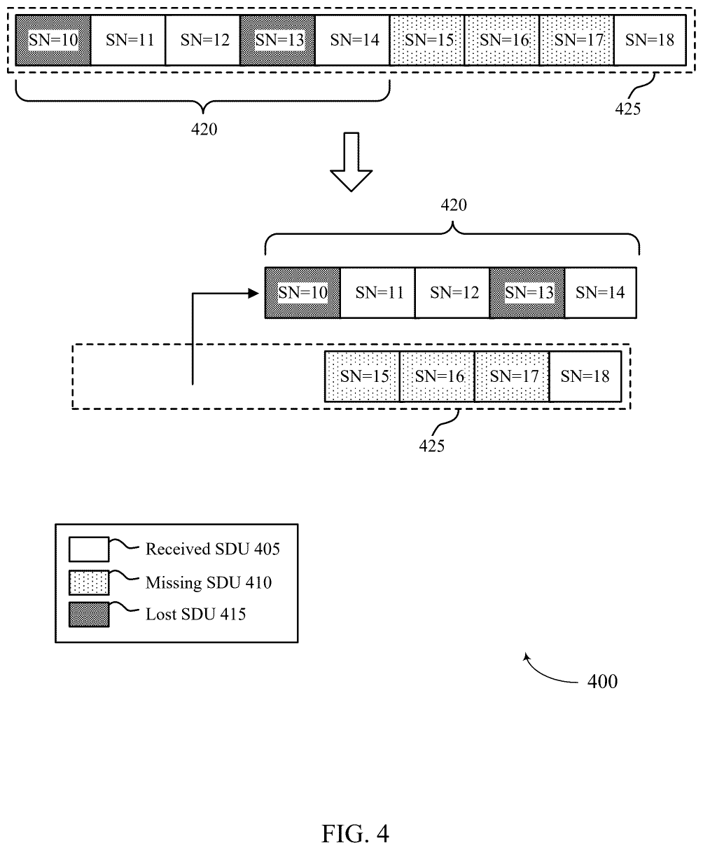

The techniques described herein may utilize an ML model (e.g., AI, ML, other algorithms), for example, for generating predictions associated with one or more PDCP SDUs received by the UE 115-a. The ML model may implement and/or function based on one or more components. For example, a first component of the ML model may include a structure, which may indicate model inputs, model outputs, and constraints for the ML model. A second component may include information reporting associated with the ML model. For example, the UE 115-a may report the selective forwarding information 215 to the network entity 105-a, and the selective forwarding information 215 may include logging information that the network entity 105-a and the UE 115-a may use to build the ML model, or ML model behavior information to monitor the ML model. A third component may include a configuration associated with using the ML model, which may include performance target configuration (e.g., KPIs), acceptable range configurations for use of the ML model, threshold capability parameters for use of the ML model, or any combination thereof. A fourth component of the ML model may include the behavior or functionality of the ML model, which may be further described herein with respect to FIGS. 3 and 4.

The structure of the ML model may include inputs, outputs, and constraints for the ML model. Additionally, or alternatively, the structure or the ML model may define a computational model for the ML model. The ML model as described herein may be any computational, data-driven model that may incorporate the inputs, outputs, and constraints described herein, and that the wireless communications system 200 may develop, train, monitor, and update the ML model based on data collected at and reported by the UE 115-a.

The inputs of the ML model may include one or more of the following: a PDCP window state, which may indicate the set of SDUs 230 that are received, as well as a time each SDU 230 or that the set of SDUs 230 were received; observed radio events, which may include successful or failed feedback (e.g., hybrid automatic request (HARQ) feedback) attempts, successful or failed RLC attempts, a reference signal received power (RSRP) associated with a channel between the UE 115-a and the network entity 105-a, a channel quality indicator (CQI) associated with the channel, or any combination thereof; and an observed upper layer state, which may include an observed transport control protocol (TCP) data packet, acknowledgment packet, or synchronization packets, and other header compression information.

The outputs of the ML model may include one or more of the following: one or more predictions (e.g., as described herein with respect to FIGS. 3 and 4), which may include predictions of which flows an SDU 230 belongs to, predictions of arrival times of one or more SDUs 230, prediction of an overall QoS at the UE 115-a, a prediction of a KPI satisfaction based on predictive decisions; and policies that the UE 115-a uses with respect to forwarding SDUs 230 based on predictions of different attributes associated with each SDU 230 (e.g., when to wait for the timer to expire, when to deliver an SDU 230 out-of-order, when to deliver the PDCP window).

In some cases, the wireless communications system 200 may configure (e.g., build) the ML model to make the one or more predictions accurately. In some cases, the oner or more predictions may include one or more attributes associated with each SDU 230, where the one or more attributes may indicate a reordering domain of the SDU 230. In some examples, the ML model may predict a flow (e.g., QoS flow, feedback flow) associated with the SDUs 230 (e.g., one or more SDUs 230, each SDU 230), a PDU set associated with the SDUs 230, a type of packet (e.g., layer 3 packet, layer 4 packet, acknowledgment, synchronization) associated with the SDUs 230, a relative latency sensitivity vs deliver-in-order-priority of the SDUs 230, or any combination thereof. The ML model may also predict a flow of an SDU 230 that is lost (e.g., failed, missing) and the reordering domain of the SDU 230 (e.g., with which other SDUs 230 of the PDCP window 225 that the SDU 230 may be reordered) based on the one or more attributes. Additionally, or alternatively, the ML model may predict an arrival latency, a likelihood of failure of an SDU 230 (e.g., probability of losing the SDU 230) that is missing from the PDCP window 225 (e.g., causing a PDCP hole), or both.

The constraints of the ML model may include one or more KPIs (e.g., ranges of performance values), which the network entity 105-a may transmit to (e.g., configure for) the UE 115-a. For example, the network entity 105-a may transmit the one or more KPIs to the UE 115-a via configurations indicated in the control messages 205. In some cases, the UE 115-a may attempt to satisfy (e.g., not violate) the KPIs. Additionally, or alternatively, the network entity 105-a may update the constraints of the ML model periodically (e.g., continuously) based on the UE 115-a reporting information associated with the ML model, like the selective forwarding information 215.

In some cases, the KPIs may assess the performance of the ML model with respect to SDU reordering and delivery (e.g., selective forwarding), and the UE 115-a may use the ML model as long as the performance of the ML model satisfies the KPIs. In some examples, a KPI may indicate an accuracy of an ML model with respect to flow prediction of SDUs 230 that are missing (e.g., late, absent). Additionally, or alternatively, a KPI may indicate a threshold quantity of SDUs 230 (e.g., a maximum quantity of SDUs 230) that the UE 115-a may deliver (e.g., forward) out-of-order (e.g., with respect to the SDUs 230 in the PDCP window 225) before expiration of the timer associated with the PDCP window 225.

In some cases, the UE 115-a may use an ML model that does not satisfy (e.g., fulfill) one or more of the KPIs. In some examples, the UE 115-a may fall back to a legacy reordering mechanism based on failing to satisfy the KPIs. For example, the UE 115-a may switch from performing selective forwarding in the PDCP window 225 to performing t-reordering by forwarding the set of SDUs 230 in the PDCP window 225 (e.g., the forwarding granularity of the PDCP window 225) based on failing to satisfy the KPI. Additionally, or alternatively, the UE 115-a may send a KPI violation report to the network entity 105-a (e.g., a network server, an AI or ML server) based on failing to satisfy the KPI.

The information reporting component associated with the ML model may indicate one or more information elements (IEs) (e.g., including labels such as meta data, timestamps) that the network entity 105-a may collect from the UE 115-a to support the ML model. In some cases, the UE 115-a may transmit the IEs (e.g., or other signaling fields) in uplink signaling, such as the selective forwarding information 215, to the network entity 105-a. For example, the UE 115-a may report information (e.g., a trace) associated with SDUs 230 that the UE 115-a has delivered (e.g., selectively forwarded), including SDUs 230 that the UE 115-a delivered in-order (e.g., with respect to the other SDUs 230 of the PDCP window 225), SDUs 230 that the UE 115-a delivered out-of-order due to the timer expiring (e.g., under a conventional approach), SDUs 230 that the UE 115-a selectively delivered out-of-order (e.g., before the timer expires), or any combination thereof.

Additionally, or alternatively, for the SDUs 230 that the UE 115-a selectively delivered out-of-order, the UE 115-a may report (e.g., in the selective forwarding information 215) a reordering policy associated with delivering the SDUs 230 out-of-order (e.g., why the UE 115-a delivered the SDUs 230 out-of-order). In some cases, the UE 115-a may report one or more attributes associated with the SDUs 230 (e.g., a reordering domain for each SDU 230, a reordering policy classification for each SDU 230). For example, the UE 115-a may report that the UE 115-a delivered an SDU 230 out-of-order (e.g., selectively) because the ML model predicted that the SDU 230 was a TCP acknowledgment, or belongs to a PDU set that the UE 115-a has already delivered. In some cases, the UE 115-a may report a flow, a sub-flow, or both, predicted by the ML model for SDUs 230 that did not arrive at the PDCP layer 220 (e.g., causing a PDCP “hole” in the PDCP window 225, lost SDUs). For example, if the ML model predicts that an SDU 230 that is missing is of a first flow, and a second flow has no PDCP holes, the UE 115-a may deliver (e.g., out-of-order, selectively forward) SDUs 230 that belong to the second flow (e.g., as described herein with respect to FIG. 3).

The UE 115-a may report additional information related to selective SDU forwarding to the network entity 105-a. For example, the UE 115-a may report an arrival time predicted by the ML model for one or more (e.g., each of the) SDUs 230 of the PDCP window 225. Additionally, or alternatively, the UE 115-a may report an indication (e.g., SNs) of SDUs 230 that the UE 115-a forwarded in-order compared to out-of-order (e.g., or a ratio of the two, a percentage of one or the other), a value of the timer when the UE 115-a selectively forwards one or more of the SDUs 230 (e.g., in the sub-window), a value of RX_REORD (e.g., a count index) when the UE 115-a selectively forwards the one or more of the SDUs 230, or any combination thereof.

Additionally, or alternatively, the UE 115-a may report a model accuracy of the ML model. In some cases, the UE 115-a may report an indication of a predicted arrival time (e.g., from the ML model) compared to an actual arrival time for one or more SDUs 230 in the PDCP window 225. In some cases, the indication may indicate to the network entity 105-a how well the ML model is performing (e.g., a qualitative indicator of performance of the ML model). As one example, the UE 115-a may report the predictions (e.g., or an accuracy of the predictions) of the ML model with respect to a reordering domain of the SDUs 230 in the buffer 235 (e.g., or the PDCP window 225), of SDUs 230 that are missing from the PDCP window 225, or both. As another example, the UE 115-a may report the predictions (e.g., or an accuracy of the predictions) of the ML model with respect to an arrival time of different SDUs 230 in the PDCP layer 220. Additionally, or alternatively, the UE 115-a may report the capability of the UE 115-a to implement the techniques described herein with the ML model, an associated accuracy of the ML model, or both.

If the UE 115-a receives one or more KPIs configured with respect to the selectively forwarding SDUs 230 from the PDCP window 225 (e.g., the threshold quantity of SDUs 230 that the UE 115-a may selectively deliver out-of-order), the UE 115-a may report an indication of a frequency with which the KPI is satisfied or unsatisfied (e.g., how much the KPI is respected or violated). For example, the UE may report the indication of the frequency if the UE 115-a delivered one or more SDUs 230 (e.g., that were missing from the PDCP window 225) before the expiration of the timer, and the one or more SDUs 230 arrive at the PDCP layer 220 after being delivered (e.g., and before expiration of the timer).

The configuration associated with the ML model for the techniques described herein may include the network entity 105-a transmitting one or more parameters to the UE 115-a via the control messages 205. For example, the one or more parameters may include threshold capabilities (e.g., or ranges of capabilities) for the UE 115-a or the ML model to be used in the wireless communications system 200. For example, if the UE 115-a or the ML model do not satisfy the threshold capabilities (e.g., the one or more parameters), the UE 115-a may not utilize the ML model to implement the techniques described herein.

Additionally, or alternatively, the configuration component of the ML model may include the network entity 105-a configuring the UE 115-a with one or more reordering parameters associated with reordering (e.g., selectively delivering) the SDUs 230. That is, the control messages 205 may include a configuration of one or more reordering parameters for the UE 115-a. In a first example, the UE 115-a may deliver one or more SDUs 230 according to the forwarding rule (e.g., as described herein with respect to FIG. 3). Table 1 may represent an example IE indicating a configuration of the one or more reordering parameters:

TABLE 1
drb:= SEQUENCE {

| | |
|---|---|
| t-Reordering | ENUMERATED { } |
| Min-t-reordering | ENUMERATED { } |
| Predicted-out-of-order-allowed | ENUMERATED {Allowed, Not |
| | Allowed } |
| Maximum-out-of-order-allowed | ENUMERATED { } |
| Out-of-order_timer | ENUMERATED { } |
| AIML_Allowed | ENUMERATED {Allowed, Not |
| | Allowed} |
| Unreceived-SDU-Prediction-allowed | ENUMERATED {Allowed, Not |
| | Allowed} } |

In Table 1: the t-Reordering parameter may indicate a reordering timer parameter (e.g., legacy reordering timer parameter); the Min-t-reordering parameter may indicate a threshold duration (e.g., minimum time) that the UE 115-a may wait before selectively forwarding an SDU 230 from the PDCP window 225 (e.g., a threshold value of the timer); the Predicted-out-of-order-allowed parameters may indicate allowable reasons for selectively forwarding an SDU 230 (e.g., before the timer expires), including a reordering domain of the SDU 230, a type of the SDU 230 (e.g., a PDU set, a flow identifier, a layer type (e.g., L3-L7) such as flow acknowledgments), or any combination thereof; the Maximum-out-of-order-allowed parameter may indicate a threshold quantity (e.g., maximum quantity) of SDUs 230 that the network entity 105-a may allow the UE 115-a to selective forward (e.g., out-of-order), where the network entity 105-a may indicate the Maximum-out-of-order-allowed parameter per flow, sub-flow, reordering domain, or any combination thereof; the Out-of-order_timer parameter may indicate a duration for counting SDUs 230 for the Max-out-of-order-allowed parameter (e.g., KPI), for example, if the Max-out-of-order-allowed parameter is maintained over a sliding time window of the duration; the AIML_Allowed parameter may indicate whether the network entity 105-a allows the UE 115-a to implement AIML behavior (e.g., the ML model); and the Unreceived-SDU-Prediction-allowed parameter may indicate whether the network entity 105-a allows the UE 115-a to selectively forward SDUs 230 based on predictions (e.g., from the ML model) with respect to a reordering domain for SDUs 230 that are missing or lost.

In a second example, the UE 115-a may deliver the one or more SDUs as part of the forwarding sub-window (e.g., as described herein with respect to FIG. 4), and Table 2 may represent an example IE indicating the configuration and the one or more reordering parameters:

TABLE 2
drb:= SEQUENCE {

| | |
|---|---|
| t-Reordering | ENUMERATED { } |
| Min-t-reordering | ENUMERATED { } |
| Maximum-out-of-order-allowed | ENUMERATED { } |
| Out-of-order_timer | ENUMERATED { } |
| Partial-window-fwding-allowed | ENUMERATED {Allowed, Not |
| | Allowed} |

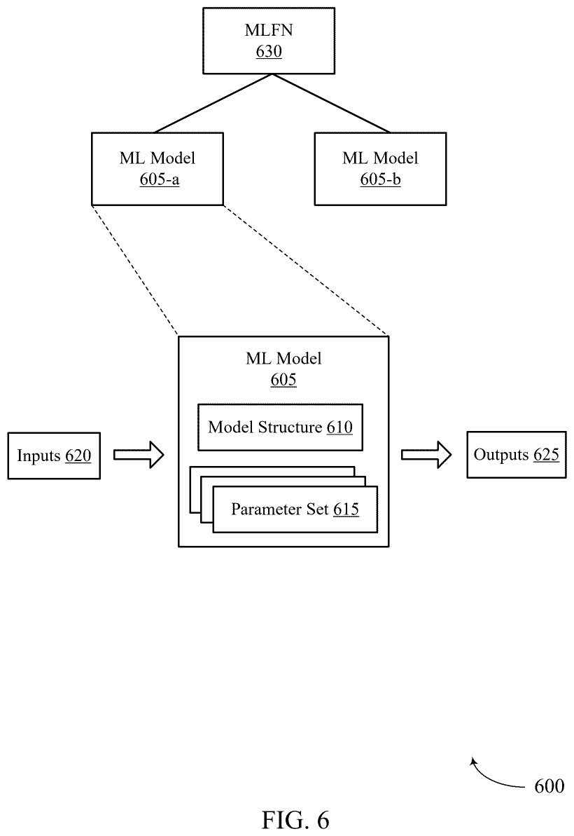

In Table 2: the t-Reordering parameter, the Min-t-reordering parameter, the Maximum-out-of-order-allowed parameter, and the Out-of-order_timer parameter may indicate similar information as described herein with reference the similar parameters in Table 1; and the Partial-window-fwding-allowed parameter may indicate whether the network entity 105-a allows the UE 115-a to forward a partial sub-window of SDUs 230 of the PDCP window 225 (e.g., as described herein with respect to FIG. 4). Additionally, or alternatively, the UE 115-a may receive an indication of one or more of the reordering parameters from Table 1 and Table 2 (e.g., a mix) if the UE 115-a delivers the one or more SDUs 230 according to the forwarding rule and as part of the forwarding sub-window. Additional description of the ML model and usage of the ML model in the wireless communications system 200 to implement the techniques described herein may be found in the descriptions of FIGS. 6 through 15 herein.

FIG. 3 shows examples of SDU forwarding diagrams 300 (e.g., an SDU forwarding diagram 300-a, an SDU forwarding diagram 300-b) that support selective SDU forwarding techniques in accordance with one or more aspects of the present disclosure. In some cases, aspects of the SDU forwarding diagrams 300 may implement or be implemented by aspects of FIGS. 1 and 2. For example, the SDU forwarding diagrams 300 may include PDCP windows 325 and one or more SDUs (e.g., received SDUs 305, missing SDUs 310, priority SDUs 315), which may be examples of the PDCP window 225 and SDUs 230, respectively, as described herein with respect to FIG. 2. Each SDU of the SDU forwarding diagrams 300 may be associated with an SN, which may merely be exemplary and in no way limiting to the techniques described herein. In some aspects, a network entity 105 may configure a UE 115 (e.g., the UE 115-a) to perform selective out-of-order processing (e.g., based on an ML model) of one or more SDUs in the PDCP windows 325, and the SDU forwarding diagrams 300 may illustrate techniques for a UE 115 to selectively forward one or more SDUs according to the forwarding rule.

In some cases, the UE 115 may selectively forward (e.g., deliver) one or more SDUs out-of-order according to the forwarding rule, as illustrated by the SDU forwarding diagrams 300. For example, the UE 115 may selectively forward the one or more SDUs based on identifying one or more reordering domains associated with the one or more SDUs. The forwarding rule may include instructions to either forward or not forward an SDU from a PDCP window 325 based on a reordering domain of the SDU as predicted by an ML model, where the reordering domain may indicate one or more features of the SDU. Additionally, or alternatively, the instructions (e.g., the forwarding rule) to either forward or not forward (e.g., selectively forward) the SDU may be based on the configurations described herein with respect to Tables 1 and 2.

In some cases, a reordering domain associated with as SDU may indicate one or more other SDUs (e.g., of the PDCP window 325) with which the SDU may be associated (e.g., and thus reordered). For example, if the ML model predicts that an SDU is associated with a QoS flow, the UE 115 may associate and reorder the SDU with one or more SDUs also predicted to be associated with the QoS flow, and the UE 115 may not associate or reorder the SDU with SDUs predicted to be associated with flows that are different from the QoS flow. In some cases, the UE 115 may selectively forward the SDUs further based on the configurations described herein with respect to Tables 1 and 2. The SDU forwarding diagrams 300-a and 300-b may be examples of selectively forwarding SDUs from a PDCP window 325 based on a reordering domain of the SDUs as predicted by the ML model.

Referring to the SDU forwarding diagram 300-a, the UE 115 may perform predictive out-of-order forwarding on one or more SDUs (e.g., a single or multiple SDUs) of the PDCP window 325-a (e.g., a current reordering window) based on a predicted flow of each SDU within the PDCP window 325-a. For example, the network entity 105 may configures the ML model to identify a flow for each SDU. In some cases, a flow may include a missing SDU 310. For example, the UE 115 may start a timer (e.g., PDCP reordering timer) based on detecting a missing SDU 310, and may forward other flows (e.g., which include one or more received SDUs 305) from the PDCP window 325-a that do not include the missing SDU 310 before the timer expires. For example, the SDU associated with the SN 10 of the PDCP window 325-a may be a missing SDU 310, and the ML model may predict that the SDUs of the PDCP window 325-a associated with the SNs 10, 16, and 17 belong to a first flow. Additionally, or alternatively, the ML model may predict that the SDUs associated with SNs 11-15 belong to a second flow, and each of the SDUs of the second flow may be received SDUs 305. Accordingly, the UE 115 may selectively forward the SDUs predicted to be part of the second flow (e.g., SDUs with SNs 11-15) which is not missing any SDUs, and may keep the SDUs of the first flow (e.g., SDUs with SNs 10, 16, and 17) which is missing an SDU within the PDCP window 325-a. In some cases, the UE 115 may wait for the timer to expire (e.g., or for the missing SDUs 310 to become received SDUs 305) before delivering the SDUs of the first flow to an upper layer in the protocol stack.

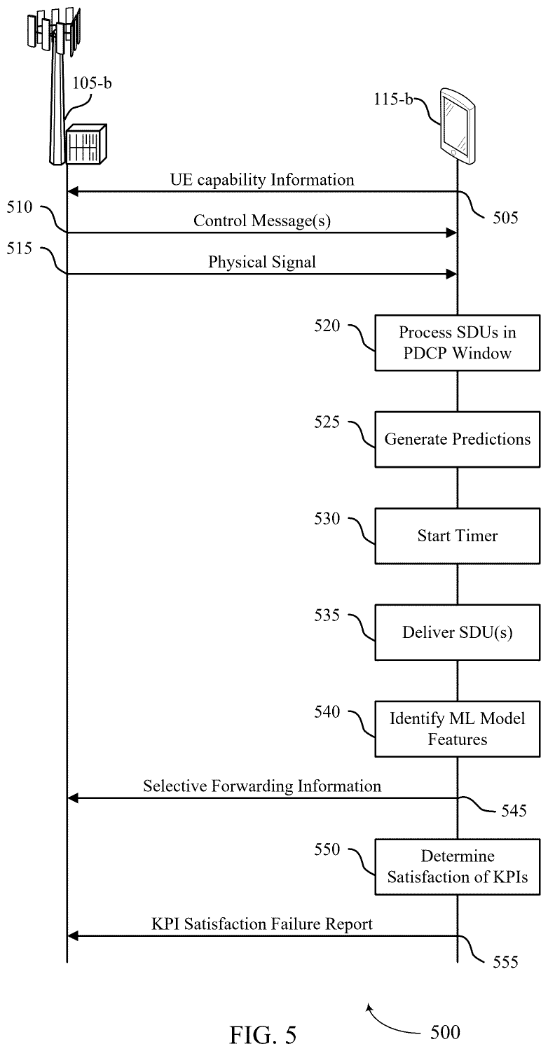

Referring to the SDU forwarding diagram 300-b, the UE 115 may perform predictive out-of-order forwarding on one or more SDUs in the PDCP window 325-b based on a predicted priority of the one or more SDUs in the PDCP window 325-b. For example, the network entity 105 may configure the ML model to identify (e.g., or predict) which SDUs of the PDCP window 325-b are priority SDUs 315. In some cases, a priority SDU 315 may be associated with one or more attributes, where the one or more attributes may indicate a reordering domain that the UE 115 prioritizes for delivering to the upper layers. The one or more attributes may be described herein with respect to FIG. 5. As an example, the ML model (e.g., or the UE 115) may predict that (e.g., classify) the SDU associated with the SN 13 of the PDCP window 325-b is associated with an attribute (e.g., TCP acknowledgment attribute, a “TCP Ack” SDU) that indicates an SDU having a relatively higher priority than other SDUs, and the UE 115 may forward the SDU associated with the SN 13 out-of-order relative to the other SDUs of the PDCP window 325-b. In this example the ML model may predict the other SDUs of the PDCP window 325-b to be associated with other attributes (e.g., “TCP data” SDUs) that indicate SDUs having a relatively lower priority than the SDU associated with the SN 13.

Additionally, or alternatively, a priority SDU 315 may be associated with an importance level of delivering the SDU in-order as compared to out-of-order, where the ML model may predict an importance level for each SDU of the PDCP window 325-b. For example, the ML model may predict that the SDU associated with the SN 13 of the PDCP window 325-b has a high importance level relative to other SDUs (e.g., the SDU is a latency-sensitive SDU, an SDU that belongs to a PDU that the UE 115 previously forwarded). Accordingly, the UE 115 may selectively forward the SDU associated with the SN 13 before an expiration of a timer associated with the PDCP window 325-b, and may keep the remainder of the SDUs in the PDCP window 325-b. In some cases, the UE 115 may forward the remainder of the SDUs after the timer expires, or when all missing SDUs 310 are received in the PDCP window 325-b.

In some cases, the UE 115 (e.g., the ML model) may predict one or more application parameters (e.g., a packet delay budget (PDB), a PDU set) for each SDU of the PDCP windows 325. Based on the prediction of the one or more application parameters, the UE may ensure that selective forwarding (e.g., reordering) does not render a selectively forwarded SDU (e.g., the individual IP packet) useless due to the reordering. For example, without such predictions, the selectively forwarded SDUs could be rendered useless due to incurring a delay beyond a respective PDB, the UE 115 processing the selectively forwarded SDU differently from one or more other SDUs in a respective PDU set, or both.

In some cases, the UE 115 may consider an SDU that is forwarded out-of-order as received and buffered by the PDCP window 325. Thus, the UE 115 may not consider SDUs that are missing from the PDCP window 325 due to selective out-of-order forwarding as PDCP holes or missing PDCP SDUs (e.g., thus the UE 115 may not begin a timer when the selectively forwarded SDUs are missing from the PDCP window 325). FIG. 4 may describe more examples of forwarding SDUs from a PDCP window prior to an expiration of a timer. One or more aspects of the techniques described with respect to the SDU forwarding diagrams 300 may apply to FIG. 4 as well.

FIG. 4 shows an example of an SDU forwarding diagram 400 that supports selective SDU forwarding techniques in accordance with one or more aspects of the present disclosure. In some cases, aspects of the SDU forwarding diagram 400 may implement or be implemented by aspects of FIGS. 1-3. For example, the SDU forwarding diagram 400 may include a PDCP window 425 and one or more SDUs (e.g., received SDUs 405, missing SDUs 410, lost SDUs 415), which may be examples of the PDCP windows (e.g., PDCP window 225, PDCP window 325) and SDUs 230, respectively, as described herein with respect to FIGS. 1-3. Each SDU of the SDU forwarding diagrams 300 may be associated with an SN, which may merely be exemplary, and are in no way limiting to the techniques described herein. In some aspects, a network entity 105 may configure a UE 115 (e.g., the UE 115-a) to perform selective out-of-order processing (e.g., based on an ML model) of a forwarding sub-window 420 of the PDCP window 425 (e.g., a current reordering window), where the forwarding sub-window 420 may be a contiguous subset of SDUs within the PDCP window 425.

In some cases, the forwarding sub-window 420 may include less SDUs (e.g., may be smaller than) the PDCP window 425. For example, the forwarding sub-window 420 may include a quantity of one or more SDUs (e.g., five SDUs in the example of FIG. 4), where the quantity of one or more SDUs in the forwarding sub-window 420 may be less than a quantity of SDUs (e.g., nine SDUs in the example of FIG. 4) in the PDCP window 425. In some cases, delivering the forwarding sub-window 420 (e.g., without one or more other SDUs of the PDCP window 425) may allow the UE 115 to selectively process SDUs from a first SDU of the PDCP window 425 (e.g., a first SDU in the PDCP window 425, RX_DELIV, a subsequent SDU) to a second SDU within the PDCP window 425 associated with an SN which the ML model may determine. In some cases, the parameters described herein with respect to Tables 1 and 2 may govern such selective SDU processing, including the forwarding sub-window 420.

Referring to the SDU forwarding diagram 400, the UE 115 may perform predictive out-of-order forwarding of one or more SDUs (e.g., a single or multiple SDUs) in the PDCP window 425 based on identifying a forwarding sub-window 420. For example, the network entity 105 may configure the ML model to identify one or more SDUs to be included in the forwarding sub-window 420 of the PDCP window 425. In some cases, the ML model may predict which SDU of the PDCP window 425 (e.g., or after the PDCP window 425) may be beneficial as a last SDU of the forwarding sub-window 420 (e.g., SN 14), and the UE 115 may determine (e.g., identify) a size of the forwarding sub-window 420 based on the prediction.

In some cases, the ML model may identify the SDU (e.g., to be included in the forwarding sub-window 420) based on one or more factors. For example, referring to the PDCP window 425, the UE 115 may determine that the SDUs associated with the SNs 10, 13, 15, 16, and 17 are missing, and may initiate a timer associated with the PDCP window 425. The ML model may predict that the SDUs associated with the SNs of 10 and 13 are lost SDUs 415 (e.g., irrecoverable, will not arrive at the PDCP layer during a timer). In such a case, the ML model may predict that the SDU associated with SN of 14 may be beneficial as a last SDU of the forwarding sub-window 420, as the UE would accordingly forward the lost SDUs 415 out of the PDCP window 425 prior to the expiration of the timer (e.g., reducing a latency associated with processing the SDUs in the PDCP window 425), while retaining more time to wait for the missing SDUs 410. In some cases, forwarding the forwarding sub-window may allow the UE 115 to forward a portion of the PDCP window 425 that the ML model predicts to include lost SDUs 415, without forwarding all of the SDUs of the PDCP window 425 before reception (e.g., such as the missing SDUs 410).

In some cases, the forwarding sub-window 420 may extend to an SDU associated with an SN greater than or equal to RX_REORD (e.g., a last SN within the PDCP window 425). In such a case, the UE 115 may deliver the SDUs of the PDCP window 425 (e.g., all the SDUs of the PDCP window) and may stop a timer associated with the PDCP window 425 accordingly. In some cases, the forwarding sub-window 420 may end with an SDU associated with an SN that is less than RX_REORD (e.g., end before the last SDU of the PDCP window 425). In such a case, the UE 115 may deliver the forwarding sub-window 420 to the upper layer, and the timer associated with the PDCP window 425 may continue (e.g., not be stopped).

FIG. 5 shows an example of a process flow 500 that supports selective SDU forwarding techniques in accordance with one or more aspects of the present disclosure. In some cases, aspects of the process flow 500 may implement or be implemented by aspects of FIGS. 1-4. For example, the process flow 500 may include a UE 115-b and a network entity 105-b, which may be examples of UEs 115 and network entities 105 as described herein with respect to FIGS. 1-4. Additionally, the description of the process flow 500 may describe SDUs, a PDCP window (e.g., PDCP reordering window), a timer (e.g., a reordering timer), and an ML model, each of which may be further described herein with respect to FIGS. 1-4. In some aspects, the UE 115-b may process one or more SDUs in a PDCP window based on a timer, and may deliver (e.g., forward) one or more SDUs of the PDCP window to an upper layer (e.g., above the PDCP layer) in a protocol stack before the timer expires.

In the following description of process flow 500, the operations may be performed in a different order than the order shown, or other operations may be added or removed from the process flow 500. For example, some operations may also be left out of process flow 500, may be performed in different orders or at different times, or other operations may be added to process flow 500. Although the UE 115-b and the network entity 105-b are shown performing the operations of process flow 500, some aspects of some operations may also be performed by one or more other wireless devices or network devices.

At 505, the UE 115-b may transmit (e.g., to the network entity 105-b) one or more capability messages indicating capability information (e.g., one or more capabilities) of the UE. For example, the capability messages may indicate a capability of the UE 115-b to support delivering a portion of a set of SDUs in a PDCP window out-of-order with respect to other SDUs in the PDCP window, before a timer associated with reordering the SDUs in the PDCP window expires, or both. Additionally, or alternatively, the capability messages may indicate an accuracy of a machine learning model at the UE 115-b with respect to one or more predictions. For example, the one or more predictions may include one or more predicted attributes of a buffered SDU (e.g., in the PDCP window), one or more predicted attributes of an SDU that has not yet arrived to the PDCP window, a predicted arrival time of respective SDUs of the set of SDUs in the PDCP window, or any combination thereof. The predictions may be further described herein at least at 535.

At 510, the UE 115-b may receive (e.g., from the network entity 105-b) one or more control messages indicating one or more parameters associated with PDCP reordering. For example, the one or more parameters may include one or more ranges associated with at least one parameter of the one or more parameters, one or more performance parameters, or any combination thereof. For example, the one or more parameters may define qualifications or threshold capabilities of an ML model for the UE 115-b to use the ML model, for example, in PDCP SDU reordering.

Additionally, or alternatively, the UE 115-b may receive a control message indicating a configuration of one or more reordering parameters. In some cases, the one or more parameters may be associated with delivering the portion of the set of SDUs of the PDCP window as part of a forwarding sub-window of the PDCP reordering window. In such cases, the one or more parameters may include a threshold duration of the timer before the UE 115-b may deliver the one or more SDUs from the PDCP window, a threshold quantity of SDUs that the UE 115-b may be allowed to forward before the timer expires, a second timer associated with a duration, an indication of whether the UE 115-b is allowed to deliver the one or more SDUs using the forwarding sub-window, or any combination thereof (e.g., as described herein with respect to FIG. 2).

Additionally, or alternatively, the one or more reordering parameters may be associated with reordering the set of SDUs, delivering the portion of the set of SDUs in accordance with a forwarding rule, or both, where delivering the one or more SDUs in accordance with the forwarding rule may be based on the configuration. For example, the one or more reordering parameters may include a first threshold duration of the timer before the UE 115-b may deliver the one or more SDUs, a second threshold duration of the timer for delivering the one or more SDUs (e.g., after which the UE 115-b may not deliver the one or more SDUs in accordance with the forwarding rule), a set of attributes for forwarding the one or more SDUs, a threshold quantity of SDUs that are the UE 115-b may be allowed to forward before the timer expires, a threshold quantity of SDUs per set of attributes that the UE 115-b may be allowed to delivered out-of-order with respect to other SDUs within the set of SDUs in the PDCP window, a second timer associated with a duration, an indication of whether the UE 115-b is allowed to use of a machine learning model for delivering SDUs of the set of SDUs, an indication of whether the UE 115-b is allowed to forward the one or more SDUs in accordance with the forwarding rule, or any combination thereof (e.g., as described herein with respect to FIG. 2).

In some cases, the UE 115-b may receive a control message (e.g., at 510) comprising an indication of one or more KPIs associated with the PDCP window (e.g., PDCP reordering window), wherein delivering the portion of the set of SDUs is based at least in part on the one or more KPIs (e.g., as described herein with respect to FIG. 2).

At 515 the UE 115-b may receive (e.g., from the network entity 105-b, from another UE 115) a physical signal (e.g., physical downlink signal, physical sidelink signal, control signal, data signal, shared signal). The physical signal may include one or more SDUs, which the UE 115-b may begin to process after receiving the physical signal. For example, the UE 115-b may process one or more portions of the physical signal through one or more layers of a protocol stack including a PDCP layer. In the PDCP layer, the UE 115-b may process one or more SDUs from the physical signal based on a PDCP window (e.g., PDCP processing window, PDCP reordering window), which may hold a quantity of SDUs (e.g., the set of SDUs) from the physical signaling at a time.

At 520, the UE 115-b may process (e.g., initiate processing of) the set of SDUs (e.g., from the physical signaling, from another signaling) using the PDCP window associated with the PDCP layer of the protocol stack of the UE 115-b. For example, the UE 115-b may process the set of SDUs by keeping a count that identifies which SDUs of the set of SDUs have arrived at the PDCP layer, and which SDUs may be missing (e.g., not yet arrived, absent) from the PDCP layer.

At 525, the UE 115-b may generate one or more predictions associated with the set of SDUs using an ML model. The ML model and the one or more predictions may be further described herein with respect to FIG. 2, as well as at 535.

At 530, the UE 115-b may start (e.g., initiate, instantiate) a timer (e.g., t-reordering, reordering timer, PDCP reordering timer) based on the count of the set of SDUs indicating that at least one SDU is missing from the set of SDUs in the PDCP window. In some aspects, the timer may be further described herein with respect to FIGS. 2-4.

At 535, the UE 115-b may deliver, from the PDCP layer to an upper layer of the protocol stack, the portion of the set of SDUs prior to an expiration of the timer. In some cases, the portion may include one or more SDUs that the UE 115-b may deliver in accordance with the forwarding rule. Additionally, or alternatively, the portion may include one or more SDUs that the UE 115-b may deliver as part of a forwarding sub-window of the PDCP window. In some cases, the forwarding rule, the forwarding sub-window, delivering the one or more SDUs as part of the forwarding sub-window of the PDCP reordering window, or any combination thereof, may be based on the one or more parameters or the configuration described at least at 510. In some cases, the portion of the set of SDUs that the UE 115-b delivers may include one or more received and buffered SDUs (e.g., the portion of the set of SDUs may be considered received and buffered at the PDCP layer by the UE 115-b).

In some cases, the UE 115-b may determine, based at least in part on the one or more predictions associated with the set of SDUs (e.g., generated at 525), whether to deliver the one or more SDUs out-of-order with respect to other SDUs of the set of SDUs in accordance with the forwarding rule. The UE 115-b may deliver the one or more SDUs to the upper layer in accordance with the determination.

In some examples, the one or more predictions may include a first prediction of respective flows associated with each SDU of the set of SDUs. For example, the UE 115-b may deliver the one or more SDUs based at least in part on the first prediction indicating that the one or more SDUs are associated with a same flow. That is, the forwarding rule may indicate that the UE 115-b may forward the one or more SDUs if the one or more SDUs are of a same flow according to the first prediction.

In some examples, the one or more predictions may include a second prediction of one or more attributes associated with each SDU of the set of SDUs. For example, the UE 115-b may deliver the one or more SDUs based on the second prediction indicating that the one or more SDUs are associated with a first attribute (e.g., of the one or more attributes) for forwarding the one or more SDUs to the upper layer before the timer expires, a second attribute for reordering the set of SDUs (e.g., before the timer expires), or both. In some cases, the one or more attributes may include a transport control protocol acknowledgment, a packet delay budget parameter, a latency parameter, a correspondence to one or more previously-delivered SDUs, a correspondence to a quality of service flow, one or more application parameters, or any combination thereof (e.g., as described herein with respect to FIG. 3).

In some examples, the one or more predictions may include a third prediction of a priority associated with each SDU of the set of SDUs. For example, the UE 115-b may deliver the one or more SDUs based on the third prediction indicating that a priority of the one or more SDUs is associated with forwarding the one or more SDUs to the upper layer before the timer expires (e.g., as described herein with respect to FIG. 3).

In some cases, the UE 115-b may determine a size of the forwarding sub-window. For example, the UE 115-b may determine the size based on a prediction of the at least one SDU missing from the set of SDUs (e.g., the at least one SDU that caused the UE 115-b to start the timer at 530) and based on one or more SDUs that have not yet been included in the PDCP reordering window (e.g., missing SDUs as described herein with respect to FIG. 4). Thus, the one or more SDUs may be delivered to the upper layer based at least in part on the size of the forwarding sub-window. (Option 1) In some cases, the timer may continue to run after the UE 115-b delivers the one or more SDUs to the upper layer (e.g., before the timer expires) in accordance with the forwarding sub-window. In some cases, the UE 115-b may determine that the size of the forwarding sub-window is at least equal to a size of the PDCP window (e.g., the one or more SDUs includes at least the set of SDUs), deliver the set of SDUs associated with the PDCP reordering window to the upper layer, and stop the timer.

At 540, the UE 115-b may identify one or more features (e.g., capabilities) associated with the ML model used for predicting the one or more SDUs that the UE 115-b delivers to the upper layer in accordance with the forwarding rule, as part of the forwarding sub-window of the PDCP reordering window, or both. For example, the one or more features may include flow detection, protocol data unit set detection, packet type detection, latency sensitivity detection, priority detection, detection of a correspondence between respective SDUs, arrival latency detection, predicted failure detection, or any combination thereof. The UE 115-b may accordingly use the ML model to predict the one or more SDUs based on the identified one or more features. In some cases, the UE 115-b may deliver the portion of the set of SDUs based at least in part on the one or more features, the ML model, or both.

At 545, the UE 115-b may transmit (e.g., to the network entity 105-b) a message comprising information (e.g., selective forwarding information). In some cases, the information may indicate SDUs that the UE 115-b delivered to the upper layer. For example, the information may include an indication of SDUs (e.g., a quantity of SDUs, indexes of SDUs, both) that the UE 115-b delivered in order with respect to the SDUs in the set of SDUs, an indication of SDUs delivered out-of-order based at least in part on the timer expiring, an indication of SDUs delivered out-of-order in accordance with the forwarding rule, an indication of SDUs delivered out-of-order as part of the forwarding sub-window of the PDCP reordering window, or any combination thereof.

Additionally, or alternatively, the UE 115-b may transmit (e.g., to the network entity 105-b) a message that may include an indication of a reordering policy that the UE 115-b used for delivering the portion of the set of SDUs to the upper layer. For example, the reordering policy may indicate one or more second parameters (e.g., forwarding parameters) used for forwarding the one or more SDUs out-of-order with respect to other SDUs of the set of SDUs.

Additionally, or alternatively, the UE 115-b may transmit (e.g., to the network entity 105-b) a message indicating information associated with the set of SDUs in the PDCP window. For example, the information may include an indication of a predicted arrival time of the one or more SDUs (e.g., that the UE 115-b delivered), an indication of the one or more SDUs that are forwarded out-of-order with respect to other SDUs of the set of SDUs, an indication of SDUs of the set of SDUs that are delivered in-order, an indication of a value of the timer when the UE 115-b delivers the portion to the upper layer, an indication of a value of the count when the UE 115-b delivers the portion to the upper layer, an indication of respective index values of SDUs in the set of SDUs, an indication of a difference between a predicted arrival time of a first SDU of the set of SDUs and an actual arrival time of the first SDU, an indication of a frequency of satisfying one or more KPIs (e.g., as described herein with respect to FIG. 2, a percentage within a moving window of instances where the UE satisfied one or more KPIs), or any combination thereof.

At 550, the UE 115-b may determine that the UE 115-b failed to satisfy the one or more KPIs (e.g., the one or more KPIs fail to be satisfied) based at least in part on delivering the portion of the set of SDUs. The one or more KPIs (e.g., and satisfaction criteria for each) may be described in more detail herein with respect to FIGS. 2-4.

At 555, based on failing to satisfy the one or more KPIs, the UE 115-b may transmit a report message comprising an indication that the one or more KPIs fail to be satisfied. Additionally, or alternatively, based on failing to satisfy the one or more KPIs, the UE 115-b may deliver, from the PDCP layer to the upper layer of the protocol stack, a second set of SDUs. For example, the UE 115-b may deliver the entire second set of SDUs (e.g., the SDUs within a second PDCP reordering window) based on an expiration of the timer associated with the second set of SDUs and failing to satisfy the one or more KPIs.

Thus, the UE 115-b may reduce a latency associated with the PDCP layer of a protocol stack by delivering or reordering SDUs within a PDCP window before an expiration of a timer.

FIG. 6 shows an example of an ML architecture 600 that supports selective SDU forwarding techniques in accordance with one or more aspects of the present disclosure. The ML architecture 600 illustrates an implementation for ML models 605 (e.g., artificial intelligence models), which may be used to perform one or more of the features described herein.

In some cases, the techniques described herein may utilize an ML model 605, which may generate a set of one or more outputs 625 based on a set of one or more inputs 620 (e.g., as described herein with respect to FIG. 2). For example, the ML model 605 may be a data driven model (e.g., algorithm), which uses ML techniques (e.g., AI techniques) to generate the outputs 625. In some cases, the ML model 605 may be described using a model structure 610. For example, the ML model 605 may include one or more computation graphs, and the model structure 610 may define a structure for the ML model 605 for generating the outputs 625. In some examples, the ML model 605 may include one or more parameter sets 615. The parameter sets 615 may be neural network weights, for example, which may be used in combination with the model structure 610 to generate the outputs 625. In some examples, the ML model 605 (e.g., alone or in combination with other ML models 605) may implement an ML function (e.g., an AI function) which may generate the outputs 625 based on the inputs 620.

In some examples, an ML feature name (MLFN) 630 may be used to identify a function performed by one or more ML models 605. For example, the MLFN 630 may correspond to CSI feedback, beam, positioning, or other functionalities. In some cases, the one or more ML models 605 may be identified using a model ID. For example, the MLFN 630 may be associated with one or more model IDs corresponding to one or more ML models 605 (e.g., an ML model 605-a and an ML model 605-b). Each model ID may correspond to (e.g., and identify) an ML model 605 having a defined model structure 610, one or more parameter sets 615, or a combination thereof, as described herein. Additionally, or alternatively, an MLFN 630 may identify one or more ML models 605 using model structure IDs (e.g., MS IDs), parameter set IDs (E.g., PS IDs), or both. For example, the MLFN 630 may be associated with one or more model structure IDs, and each structure ID may identify a model structure 610 of an ML model 605. The MLFN 630 (e.g., or each structure ID) may also be associated with one or more parameter set IDs, each parameter set ID identifying a corresponding parameter set 615 for use with the corresponding model structure 610.

As such, model information may include MLFNs 630, model IDs, a model structure IDs, parameter set IDs, or a combination thereof. In some examples, each model ID may be associated with a model structure and one or more parameter sets, and may be represented by a string. For instance, the string may correspond to a flat namespace, such as a single value that represents a tuple that includes the model structure and the one or more parameter sets. Alternatively, the string may be a hierarchical namespace, such as the tuple including the model structure and the one or more parameter sets.

In some cases, each model ID may be unique with respect to an MLFN 630. For example, each model ID may identify a separate ML model 605 (e.g., for a vendor), and may be unique such that each model ID refers to a single corresponding ML model 605. Similarly, each model structure ID may also be unique with respect to an MLFN 630. In some cases, each model ID, model structure ID, or both, may be specific to a public land mobile network (PLMN). Additionally, or alternatively, the model IDs and model structure IDs may be standardized or may administered separately (e.g., per vendor) without standardizing.

A network entity 105 (e.g., a network) may configure and manage the use of ML models 605 for a UE 115. In some examples, the network entity 105 may manage ML at the UE 115 at a feature level, for example, by configuring the UE 115 by indicating an MLFN 630. Additionally, or alternatively, the network entity 105 may manage ML models 605 within each feature, and may configure the UE 115 using specific model IDs (e.g., indicating a model structure 610 and one or more parameter sets 615) corresponding to each feature. In some examples, the network entity 105 may manage the parameters of each ML model, and the network entity 105 may configure the UE 115 by indicating a model structure ID corresponding to a model structure 610 and one or more parameter sets 615. The parameter sets 615 may be explicitly indicated by the network entity 105 to the UE 115, which may allow for more flexibility of the parameters, and may reduce the storage requirements at the UE 115 for storing predetermined parameter sets 615. Alternatively, the network entity 105 may indicate the parameter sets 615 using one or more parameter IDs, which may reduce communication overhead between the UE 115 and the network entity 105.

In some examples, ML models 605 may be one-sided models, which may be performed entirely at a UE 115 or the network (e.g., at one or more network entities 105), or two-sided models, which may be performed at both the UE 115 and the network. One-sided models may be UE-side ML models 605, in which inference (e.g., running of the ML models 605) is performed at the UE 115. For example, the UE-side ML models 605 may involve non-UE specific inputs 620 (e.g., common to multiple UEs 115) and UE-specific inputs 620 (e.g., control inputs 620). In some cases, the UE 115 may receive control signaling or additional inputs 620 for the ML models 605 from a network entity 105, while the ML model 605 inference is performed entirely at the UE 115. Inference for network-side ML models 605 may be performed at the network (e.g., at one or more network entities 105), and the network may receive inputs 620 from the UE 115 to enter into the ML models 605. In some examples, the network may indicate the outputs 625 to the UE 115.

In two-sided ML models 605, joint inference may be performed. For example, one part of inference may be performed by the UE 115, and a remaining portion of the inference may be performed by one or more network entities 105. For example, the UE 115 may perform a first portion of the inference for an ML model 605, and the network may perform a second part of the inference (e.g., based on data received from the UE 115, for example). Alternatively, the network may perform the first portion of the inference for an ML model 605, and the UE 115 may perform the second part of the inference (e.g., based on data received from the network entity 105, for example). To perform inference for the two-sided ML model 605, a network entity 105 may signal one or more inputs 620 or other control signaling to the UE 115. Additionally, or alternatively, the UE 115 may transmit signaling indicating one or more inputs 620 or other control signaling to the network.

Accordingly, the ML models 605 may be performed at a UE 115 or at one or more network entities 105, as managed by the network, to perform different functions that may improve the operations and efficiency of the UE 115 and the network as described herein. For example, the ML models 605 may be used to support the techniques of selective SDU delivery in accordance with the described techniques, which may include techniques for dynamically and selectively forwarding SDUs, for example, based on considerations of the flow and/or priority associated with the SDU. Here, a UE 115 may begin a timer (e.g., the t-reordering timer) associated with a PDCP window based on a first SDU being absent from the PDCP window, and the UE 115 may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115 may forward the portion based on a forwarding rule, as part of a forwarding sub-window (e.g., the sub-window being smaller than the PDCP window) of the PDCP window, or both. Thus, the UE 115 may reduce the forwarding granularity at the PDCP layer, and the UE 115 may reduce latency associated with the timer and the PDCP layer.

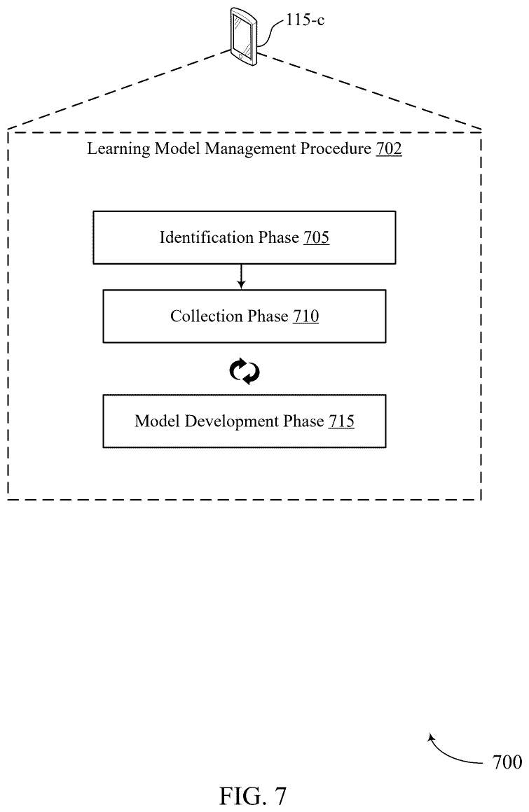

FIG. 7 shows an example of a block diagram 700 of a UE 115-c that supports selective SDU forwarding techniques in accordance with one or more aspects of the present disclosure. The UE 115-c may be an example of aspects of a UE 115 as described herein with reference to FIGS. 1 and 2, respectively. The UE 115-c may implement aspects of the wireless communications system 100 and the wireless communications system 200, as described with reference to FIGS. 1 and 2, respectively.

In the example of FIG. 7, the UE 115-c may support a learning model management procedure 702 associated with one or more ML models for selective SDU forwarding, as described herein. In some cases, the term “learning model,” as used herein, may be used interchangeably with “ML model.” The learning model management procedure 702 may include one or more of an identification phase 705, a collection phase 710 (also referred to as a data collection phase), and a model development phase 715.

One or more operations of the learning model management procedure 702 may be implemented by the UE 115-c or components (e.g., one or more memories storing processor-executable code, one or more processors coupled with the one or more memories and individually or collectively operable to execute the code to cause the UE 115-c to perform the operations) as described herein. In the following description of the learning model management procedure 702, the one or more operations performed by the UE 115-c may be performed in different orders or at different times. Some operations may also be omitted from the learning model management procedure 702, and other operations may be added to the learning model management procedure 702.

During the identification phase 705, the UE 115-c may identify an opportunity of applying a learning model. For example, the UE 115-c may identify a machine learning feature (MLF) for development at the UE 115-c. The UE 115-c may determine a use case for the learning model. In some examples, the UE 115-c may determine a task (e.g., an action) associated with the learning model, may determine inputs and outputs of the learning model, or both.

During the collection phase 710, the UE 115-c may collect data. For example, the UE 115-c may collect data based on actions or measurements that the UE 115-c performs, or the UE 115-c may collect data from multiple network elements (e.g., UEs, network entities). The data collected may be used as an input to the learning model for model development.

During the model development phase 715, the UE 115-c may prepare the data (e.g., before inputting the data to the learning model, as part of inputting the data to the learning model). To prepare the data, the UE 115-c may utilize one or more data filters, one or more selection criteria, or other data preparation parameters or procedures. The UE 115-c may design the model. A design of the learning model may be based on the MLF, the data available to the UE 115-c, one or more target outputs of the learning model, or a combination thereof. The UE 115-c may train the learning model (e.g., using the input data), and the UE 115-c may perform validation and testing of the learning model. For example, the UE 115-c may determine an accuracy or a reliability of the learning model and may calculate one or more accuracy metrics of the learning model. In some examples, the UE 115-c may continue to collect data for the learning model until the learning model has reached a threshold accuracy or reliability.

In some examples, multiple models may be developed for a same MLF (e.g., a same use case). The different models may be applicable to difference deployment environments, scenarios, or regions (e.g., geographical regions). In some examples, learning models may be universal models and may be generalized models that are applicable across deployments (e.g., all deployments). Universal models may be device specific or hardware specific. Some learning models may be regional models which may be deployment specific or network specific. Regional models may be applicable to some deployments, networks, and/or regions, but not others. Some learning models may be local models which may be applicable to a specific cell or to a local geographical area.

In some examples, the UE 115-c may be capable of out-of-band or on-demand download of learning models. For example, because some models may be regional models or local models, the UE 115-c may download such learning models once the UE 115-c is in the field (e.g., on-demand downloading). In some examples, on-demand downloading of learning models at the UE 115-c may enable the UE 115-c to perform firmware over-the-air (FOTA) updates of existing models (e.g., downloaded models, such as out-of-band downloaded models), which may support federated learning of learning models.

Additionally, or alternatively, the learning model management procedure 702 may include a deployment of one or more learning models. For example, a UE 115-c may perform delivery or reception of a learning model (e.g., via an over the air interface or other signaling). That is, the UE 115-c may transmit an indication of the learning model to a network entity 105 or may receive an indication of the learning model from a network entity 105. In some examples, the indication of the learning model may indicate a partial model or a full model. A structure of the learning model may be known at a device receiving the learning model and the indication may include parameters for the model, or the indication may include a model (e.g., a model structure unknow by the receiving device) and parameters for the model.

In some examples, the indication of the learning model may include a model executable. The model executable may be optimized for different hardware platforms based on capabilities of the hardware platform and/or performance tradeoffs. The model executable may be downloaded directly to the UE 115-c or may be retrieved by the UE 115-c from a model repository. In some cases, due to a memory restriction at the UE 115-c, the UE 115-c may download the learning model at runtime.

In some examples, the indication of the learning model may include one or more model management protocols. The model management protocols may include network and/or UE protocol functions to run the model. Additionally, or alternatively, the model management protocols may include L1/L2 or RRC function handling (e.g., CSI type III support, MAC-control elements (MAC-CEs), RRC signaling for channel state feedback (CSF) configuration. In some cases, the model management protocols may include updated UE capabilities handling information (e.g., UE radio capability for CSF and supported CSF models).

In some examples, the UE 115-c may retrieve the learning model from one or more model repositories. The model repository may store the model to download (e.g., transfer) to the UE 115-c. In some examples, the model repository may be a server (e.g., mobile network operator (MNO)). A model and parameter set configuration (e.g., indicating a set of learning models to be downloaded to the UE 115-c) may be configurable (e.g., dynamic), or may be static. Downloading the learning model to the UE 115-c may be in accordance with a model download format. The model download format may be a binary executable file or image or may be a model descriptor or label (e.g., in accordance with an open neural network exchange (ONNX)). In some examples, model quantization and/or compilation may be during an out-of-band period or may be during a runtime period of the UE 115-c.

A learning model may undergo a life cycle, where the learning model progresses from one step of the life cycle to another. Steps of the model life cycle may include model development, model deployment, and model execution. For example, after development of a learning model, the learning model may be deployed. Based on a model deployment, the UE 115-c may collect feedback of the ML model and may perform additional model development of the learning model (e.g., to improve or iterate on the learning model) based on the feedback. After model deployment, the ML model may be configured (e.g., for a particular use case, scenario), and the ML model may be executed by the UE 115-c (e.g., as described in greater detail with reference to FIG. 5). Based on model execution, the UE 115-c may collect feedback, may collect additional data, or both. The UE 115-c may perform model development of the ML model to improve the ML model based on the feedback and the additional data collected.

As described herein, the UE 115-c may support techniques for dynamically and selectively forwarding SDUs, for example, based on considerations of the flow and/or priority associated with the SDU. In such cases, the UE 115-c may use an ML model, which may be implemented using the learning model management procedure 702, for example, for predicting one or more attributes associated with PDCP SDUs received by the UE 115-c. In some examples, the UE 115-c may begin a timer (e.g., the t-reordering timer) associated with a PDCP window based on a first SDU being absent from the PDCP window, and the UE 115-c may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-c may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-c may reduce the forwarding granularity of the PDCP layer, and the UE 115-c may reduce latency associated with the timer and the PDCP layer.

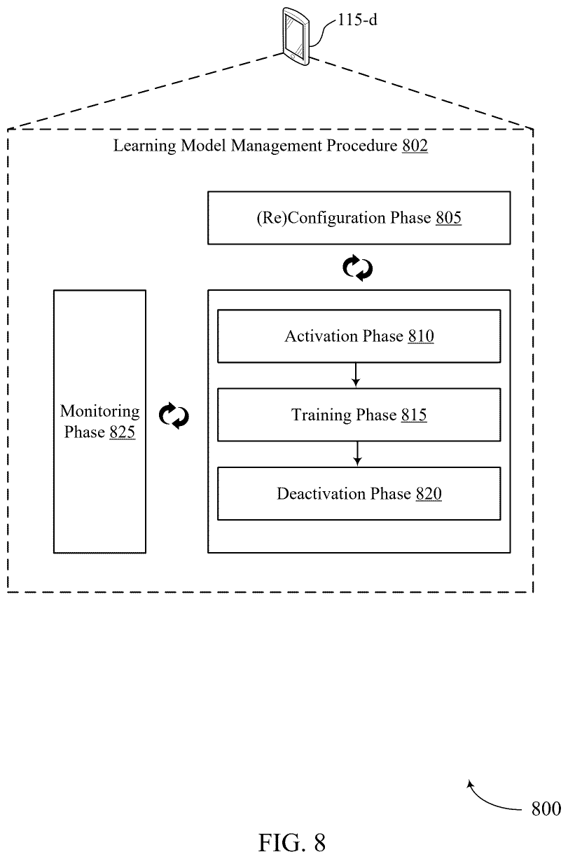

FIG. 8 shows a block diagram 800 of a UE 115-d that supports selective SDU forwarding techniques in accordance with one or more aspects of the present disclosure. The UE 115-d may be an example of aspects of a UE 115 as described herein with reference to FIGS. 1, 2, and 3, respectively. The UE 115-d may implement aspects of the wireless communications system 100 and the wireless communications system 200, as described with reference to FIGS. 1 and 2, respectively.

In some examples, a UE 115-d may support a learning model management procedure 802 associated with one or more ML models for selective SDU forwarding techniques, as described herein. The learning model management procedure 802 may include one or more of a (re) configuration phase 805, an activation phase 810, a training phase 815 (also referred to as an inference phase), a deactivation phase 820, or a monitoring phase 825. The one or more learning models may be locally stored (e.g., one or more memories storing processor-executable code) at the UE 115-d. Alternatively, the UE 115-d may obtain (e.g., download) the one or more learning models, for example, via a network entity 105 or a base station, as described herein with reference to FIGS. 1 and 2.

One or more operations of the learning model management procedure 802 may be implemented by the UE 115-d or components (e.g., one or more memories storing processor-executable code, one or more processors coupled with the one or more memories and individually or collectively operable to execute the code to cause the UE 115-d to perform the operations) as described herein. In the following description of the learning model management procedure 802, the one or more operations performed by the UE 115-d may be performed in different orders or at different times. Some operations may also be omitted from the learning model management procedure 802, and other operations may be added to the learning model management procedure 802.

During the (re) configuration phase 805, the UE 115-d may receive, from a network entity 105 or a base station, a set of one or more configurations including a set of one or more parameters for configuring or reconfiguring one or more learning models (e.g., artificial intelligence models, ML models). The UE 115-d may receive, from a network entity 105 or a base station, a request message for configuring or reconfiguring the one or more learning models. The request may include the set of one or more configurations and one or more identifiers associated with one or more learning models. The UE 115-d may transmit, to the network entity 105 or the base station, a response message that includes an acknowledgment of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as KPIs) for the one or more learning models. Additionally, or alternatively, the set of one or more configurations may include one or more RRC configurations (e.g., one or more measurement configurations, one or more MAC configurations, or the like).

During the activation phase 810, the UE 115-d may activate at least one learning model (e.g., for at least one action). During the training phase 815, the UE 115-d may train the at least one learning model to obtain a set of one or more outputs based at least in part on a set of one or more inputs (e.g., a set of one or more parameters). During the deactivation phase 820, the UE 115-d may deactivate the at least one learning model (e.g., for at least one action).

During the monitoring phase 825, the UE 115-d may monitor (e.g., track) a performance of the at least one learning model. One or more of a network entity 105, a base station, or the UE 115-d may share (e.g., transmit, receive, exchange) feedback associated with the performance of the at least one learning model. The performance may be associated with a system performance (e.g., spectral efficiency, power consumption, delay, or the like) or a model performance (e.g., prediction accuracy, resource usage, inference delay, or the like). In some examples, one or more of a network entity 105, a base station, or the UE 115-d may trigger a switching event that includes switching (e.g., changing) from at least one learning model to at least one different learning model, for example, based at least in part on feedback associated with a performance of the at least one learning model. In some other examples, one or more of a network entity 105, a base station, or the UE 115-d may update the training of the at least one learning model based at least in part on the feedback associated with the performance of the at least one learning model.

The UE 115-d may switch from at least one learning model to at least one different learning model based at least in part on a function supported by the different learning model. In some examples, the UE 115-d may receive, from a network entity 105 or a base station, a request message to switch to the at least one different learning model. The request message may indicate an identifier associated with the at least one different learning model, and the UE 115-d may identify the least one different learning model based at least in part on the identifier. During the activation phase 810 of the learning model management procedure 802, the UE 115-d may activate the at least one different learning model (e.g., a different artificial intelligence/ML model). Additionally, during the deactivation phase 820, the UE 115-d may deactivate the at least one learning model (e.g., a current artificial intelligence/ML model).

Additionally, or alternatively, during the monitoring phase 825, the UE 115-d may trigger the switching event based at least in part on a change in one or more parameters of the UE 115-d (e.g., a quantity of antennas, a quantity of carriers, etc.). In some examples, the UE 115-d may trigger the switching event based at least in part on a change in a location of the UE 115-d (e.g., a change from an indoor environment to an outdoor environment, or vice-versa). In some other examples, the UE 115-d may trigger the switching event based at least in part on a change in a service (e.g., network slice, QoS flow, session, etc.).

Accordingly, the UE 115-d may be configured to support managing (e.g., configuring, reconfiguring, activating, deactivating, monitoring, reporting, or the like) of one or more machine leaning models. For example, as described herein, the UE 115-d may support techniques for dynamically and selectively forwarding SDUs, which may be based on considerations of the flow and/or priority associated with the SDU. In such cases, the UE 115-d may use an ML model, which may be implemented using the learning model management procedure 802, for predicting one or more attributes associated with PDCP SDUs received by the UE 115-d. That is, the ML model may output one or more predictions about SDUs, which the UE 115-d may use for selective/dynamic out-of-order delivery of the SDUs. In some examples, the UE 115-d may begin a timer (e.g., the t-reordering timer) associated with a PDCP window based on a first SDU being absent from the PDCP window, and the UE 115-d may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-d may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-d may reduce the forwarding granularity of the PDCP layer, and the UE 115-d may reduce latency associated with the timer and the PDCP layer.

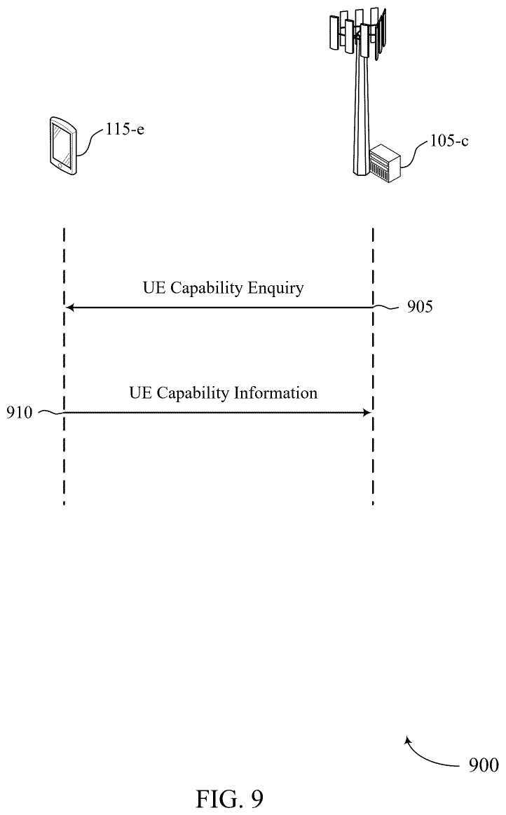

FIG. 9 shows an example of a process flow 900 that supports selective SDU forwarding techniques in accordance with one or more aspects of the present disclosure. The process flow 900 may implement aspects of the wireless communications system 100 and the wireless communications system 200, as described with reference to FIGS. 1 and 2, respectively. The process flow 900 may include a UE 115-e and a network entity 105-c, which may be examples of UEs 115 and network entities 105 as described herein. In the following description of the process flow 900, the operations between the UE 115-e and the network entity 105-c may be transmitted in a different order than the example order shown, or the operations performed by the UE 115-e and the network entity 105-c may be performed in different orders or at different times. Some operations may also be omitted from the process flow 900, and other operations may be added to the process flow 900.

In some examples, the UE 115-e may support providing an indication to the network entity 105-c of one or more ML models, including one or more features for selective SDU forwarding techniques, supported by the UE 115-e. At 905, the network entity 105-c may transmit, and the UE 115-e may receive, a request message (e.g., a UE capability enquiry). The UE 115-e may determine, in response to the UE capability enquiry, a set of one or more UE capabilities. For example, the UE 115-e may determine whether the UE 115-e supports AI/ML models and or functionalities, including one or more ML models (e.g., AI/ML models) or one or more features associated with the one or more learning models.

At 910, the UE 115-e may transmit, and the network entity 105-c may receive, a response messages (e.g., UE capability information), in response to the request message. The UE capability information may include a set of one or more features supported by the UE 115-e. In some examples, the UE capability information may include a set of one or more identifiers associated with the one or more learning models, supported by the UE 115-e. Additionally, or alternatively, the UE capability information may include at least one field (e.g., an IE, a flag, or the like) that indicates whether a corresponding learning model is loaded (e.g., initialized, stored, cached, or the like) at the UE 115-e. Additionally, or alternatively, the UE capability information may include a set of one or more identifiers associated with one or more learning model structures, or a set of one or more parameters for one or more features associated with the one or more learning model structures.

Accordingly, the UE 115-e may be configured to support exchange of UE capability information associated with one or more learning models. Further, the UE 115-e may support techniques for dynamically and selectively forwarding SDUs, which may be based on aspects of the flow and/or priority associated with one or more SDUs. In such cases, the UE 115-e may use an ML model, which may be based on the UE capability information exchanged with the network entity 105-c, for predicting one or more attributes associated with PDCP SDUs received by the UE 115-e. That is, the ML model may output one or more predictions about SDUs, which the UE 115-e may use for selective/dynamic out-of-order delivery of the SDUs. In some examples, the UE 115-e may begin a timer (e.g., the t-reordering timer) associated with a PDCP window based on a first SDU being absent from the PDCP window, and the UE 115-e may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-e may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-e may reduce the forwarding granularity of the PDCP layer, and the UE 115-e may reduce latency associated with the timer and the PDCP layer.

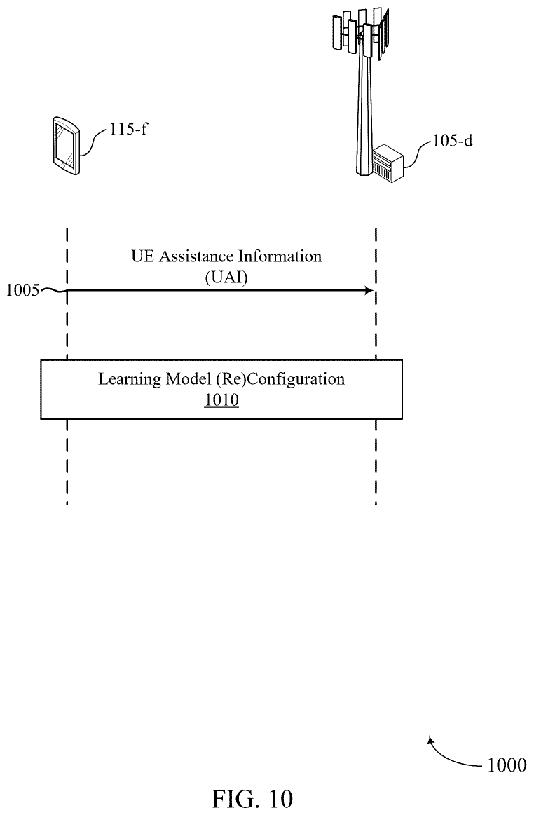

FIG. 10 shows an example of a process flow 1000 that supports selective SDU forwarding techniques in accordance with one or more aspects of the present disclosure. The process flow 1000 may implement aspects of the wireless communications system 100 and the wireless communications system 200, as described with reference to FIGS. 1 and 2, respectively. The process flow 1000 may include a UE 115-f and a network entity 105-d, which may be examples of UEs 115 and network entities 105 as described herein. In the following description of the process flow 1000, the operations between the UE 115-f and the network entity 105-d may be transmitted in a different order than the example order shown, or the operations performed by the UE 115-f and the network entity 105-d may be performed in different orders or at different times. Some operations may also be omitted from the process flow 1000, and other operations may be added to the process flow 1000.

In some examples, the UE 115-f may support providing UE assistance information (UAI) to the network entity 105-d. More specifically, the UE 115-f may support transmitting, to the network entity 105-d, UAI for managing one or more learning models. At 1005, the UE 115-f may transmit, and the network entity 105-d may receive, UAI that may indicate one or more restrictions (also referred to as restricted UE capabilities) associated with the one or more learning models. For example, the restricted UE capabilities may include a set of one or more learning models, a set of one or more identifier associated with the set of one or more learning models, or both. In some examples, the restricted UE capabilities may exclude the set of one or more identifiers. In some examples, the UE 115-f may indicate a request to adjust (e.g., reduce, decrease, increase) a concurrency of the one or more learning models. For example, the UE 115-f may indicate a threshold quantity of concurrency (e.g., “maxartificial intelligencemachine learningconcurrency-Preference”) associated with the one or more ML models.

The UE 115-f may generate and transmit the UAI to the network entity 105-d based at least in part on a condition (e.g., an event). One or more examples of a condition may include, but is not limited to, a battery level of the UE 115-f satisfying a battery level threshold, a processor usage level of one or more processors of the UE 115-f satisfying a processor usage level threshold, or a heat level of one or more processors of the UE 115-f satisfying a heat level threshold. For example, the UE 115-f may transmit the UAI to the network entity 105-b to manage (e.g., deactivate, activate) one or more learning models at the UE 115-f based at least in part on one or more of the battery level of the UE 115-f satisfying the battery level threshold, the processor usage level of the one or more processors of the UE 115-f satisfying the processor usage level threshold, or the heat level of the one or more processors of the UE 115-f satisfying the heat level threshold.

Additionally, or alternatively, in some examples, the UAI may include a request for a set of one or more configurations associated with one or more learning models. In some examples, the UE 115-f may request the network entity 105-b for the set of one or more configurations associated with the one or more learning models based at least in part on a change in an environment of the UE 115-f. In some other examples, the UE 115-f may request the network entity 105-d for the set of one or more configurations associated with the one or more learning models based at least in part on a change in a state of the UE 115-f (e.g., a change between one or more of an idle state, an inactive state, or a connected state).

In other examples, the UE 115-f may request the network entity 105-d for the set of one or more configurations associated with the one or more learning models based at least in part on a session establishment associated with a network slice. For example, the UE 115-f may establish a session (e.g., a PDU session) associated with the network slice, and request the network entity 105-d for the set of one or more configurations associated with the one or more learning models. In some other examples, the UE 115-f may request the network entity 105-d for the set of one or more configurations associated with the one or more learning models based at least in part on a change in a geographic coverage area of the UE 115-f. For example, the UE 115-f may enter a new geographic coverage area of a cell, PLMN, and request the network entity 105-d for the set of one or more configurations associated with the one or more learning models.

At least one configuration of the set of one or more configurations associated with provisioning of network data as input for one or more learning models (e.g., AI/ML models). In some examples, the at least one configuration may indicate at least one identifier associated with at least one learning model supporting the network data as input to the least one learning model. In some examples, the UE 115-f may request (e.g., on-demand) for the network data from the network entity 105-d via the UAI, for example, based at least in part on the set of one or more configurations associated with provisioning of network data as input for one or more learning models (e.g., AI/ML models).

At 1010, one or more of the UE 115-f or the network entity 105-d may configure or reconfigure at least one learning model. For example, the network entity 105-d may select at least one learning model to deactivate at the UE 115-f, based at least in part on the UAI, and transmit control signaling (e.g., RRC, MAC-CE, DCI) for deactivating the at least one learning model. For example, the network entity 105-d may determine and select which learning model to deactivate at the UE 115-f based at least in part on the UAI, and transmit the control signaling (e.g., RRC, MAC-CE, DCI) that indicates for the UE 115-f to deactivate the at least one learning model. Additionally, or alternatively, the network entity 105-d may determine and select which learning model to configure or reconfigure and activate at the UE 115-f based at least in part on the UAI. For example, the network entity 105-d may determine and select which learning model to activate at the UE 115-f based at least in part on the UAI, and transmit control signaling (e.g., RRC, MAC-CE, DCI) that indicates for the UE 115-f to activate the at least one learning model.

Accordingly, the UE 115-f may be configured to support exchange of UAI for managing ML models that support selective SDU forwarding techniques at the UE 115-f. For example, the UE 115-f may support techniques for dynamically and selectively forwarding SDUs, which may be based on aspects of the flow and/or priority associated with one or more SDUs. In such cases, the UE 115-f may use an ML model, which may be configured (or re-configured) based on the UAI provided to the network entity 105-d, for predicting one or more attributes associated with PDCP SDUs received by the UE 115-f. That is, the ML model may output one or more predictions about SDUs, which the UE 115-f may use for selective/dynamic out-of-order delivery of the SDUs. In some examples, the UE 115-f may begin a timer (e.g., the t-reordering timer) associated with a PDCP window based on a first SDU being absent from the PDCP window, and the UE 115-f may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-f may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-f may reduce the forwarding granularity of the PDCP layer, and the UE 115-f may reduce latency associated with the timer and the PDCP layer.

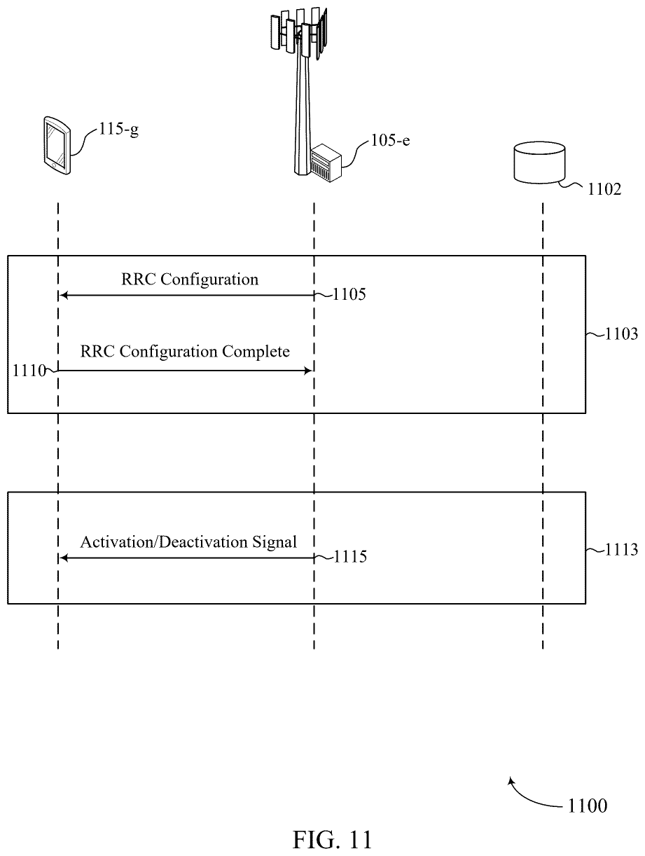

FIG. 11 shows an example of a process flow 1100 that supports selective SDU forwarding techniques in accordance with one or more aspects of the present disclosure. The process flow 1100 may implement aspects of the wireless communications system 100 and the wireless communications system 200, as described with reference to FIGS. 1 and 2, respectively. The process flow 1100 may include a UE 115-g and a network entity 105-e, which may be examples of UEs 115 and network entities 105 as described herein. Additionally, the process flow 1100 may include a repository 1102 (e.g., a database) storing one or more ML models, or information regarding the same. In the following description of the process flow 1100, the operations between the UE 115-g, the network entity 105-e, and/or the repository 1102 may be transmitted in a different order than the example order shown, or the operations performed by the UE 115-g, the network entity 105-e, and/or the repository 1102 may be performed in different orders or at different times. Some operations may also be omitted from the process flow 1100, and other operations may be added to the process flow 1100.

In some examples, one or more of the UE 115-g or the network entity 105-e may support performing one or more procedures 1103 (e.g., a model configuration procedures) and/or one or more procedures 1113 (e.g., model activation/deactivation procedures), which may include an exchange of one or more messages indicating a set of one or more configurations (or a set of one or more parameters) associated with one or more learning models. The set of one or more configurations (or the set of one or more parameters) associated with the one or more learning models may be stored at a repository 1102 (e.g., a database, or the like), which the network entity 105-e may obtain from the repository 1102.

At 1105, the network entity 105-e may transmit, and the UE 115-g may receive, an RRC configuration message, which may include one or more sets of one or more configurations (or one or more sets of one or more parameters) associated with one or more ML models for AI/ML-enabled selective SDU forwarding. The network entity 105-e may transmit, and the UE 115-g may receive, the RRC configuration message during the procedure 1103, which may be an RRC configuration procedure. In some examples, the UE 115-e may configure one or more learning models via L3 signaling and based on the one or more sets of one or more configurations (or the one or more sets of one or more parameters) received in the RRC configuration message.

At 1110, the UE 115-g may transmit, and the network entity 105-e may receive, an RRC configuration complete message, for example, based at least in part on the RRC configuration message. The RRC configuration complete message may indicate a completion of the RRC configuration procedure 1103 (e.g., the RRC configuration procedure), including configuring of the one or more learning models for AI/ML-enabled selective SDU forwarding, including configuring of the one or more ML models.

In the example of FIG. 11, additionally, or alternatively, at least one configuration of the sets of one or more configurations may be for provisioning network data by the network entity 105-e to the UE 115-g for input to one or more learning models (e.g., AI/ML models). In some examples, the at least one configuration may indicate at least one identifier associated with at least one learning model supporting the network data as input to the least one learning model. In some examples, the UE 115-g may request, the network entity 105-e, to activate or deactivate provisioning of network data as input to the at least one learning model via a MAC-CE. In some examples, the UE 115-g may receive, and the network entity 105-e may transmit, the network data via a unicast transmission and over a physical downlink channel (e.g., a physical downlink control channel (PDCCH), a physical downlink shared channel (PDSCH)). In some other examples, the UE 115-g may receive, and the network entity 105-e may transmit, the network data via a MAC-CE or an RRC message. In other examples, the UE 115-g may receive, and the network entity 105-e may transmit (e.g., broadcast), the network data via system information or a multicast broadcast service (MBS) transmission.

Additionally, or alternatively, at least one configuration of the sets of one or more configurations may be for provisioning, to the network entity 105-e, UE data as input for one or more learning models (e.g., AI/ML models). In some examples, the at least one configuration may indicate at least one identifier associated with at least one learning model supporting the UE data as input to the least one learning model. The network entity 105-e may request, from the UE 115-g, to activate or deactivate provisioning of UE data as input to the at least one learning model via a MAC-CE. In some examples, the UE 115-g may transmit, and the network entity 105-e may receive, UE data via a unicast transmission and over a physical uplink channel (e.g., a physical uplink control channel (PUCCH), a physical uplink shared channel (PUSCH)). In some other examples, the UE 115-g may transmit, and the network entity 105-e may receive, the UE data via a MAC-CE or an RRC message.

At 1115, the network entity 105-e may transmit, and the UE 115-g may receive, a signal (also referred to as an activation signal or a deactivation signal) for activating or deactivating one or more learning models for AI/ML-enabled selective SDU forwarding, which may be activated/deactivated during a procedure 1113 (e.g., an activation/deactivation procedure of one or more ML models for AI/ML-enabled selective SDU forwarding). In some examples, the network entity 105-e may transmit, and the UE 115-g may receive, via L2 signaling, the signal for activating or deactivating the one or more learning models. For example, the network entity 105-e may transmit, and the UE 115-g may receive, a MAC-CE that activates or deactivates the one or more learning models. In some examples, activating or deactivating the one or more learning models may be based at least in part on a switching event.

Accordingly, one or more of the UE 115-g or the network entity 105-e may be configured to support managing one or more ML models based at least in part on activating or deactivating one or more learning models via MAC-CE, which allows selective SDU forwarding at the UE 115-g. In some aspects, the UE 115-g may support techniques for dynamically and selectively forwarding SDUs, which may be based on aspects of the flow and/or priority associated with one or more SDUs. In such cases, the UE 115-g may use one or more ML models, which may be managed in accordance with the process flow 1100, for predicting one or more attributes associated with PDCP SDUs received by the UE 115-g. That is, the ML model may output one or more predictions about SDUs, which the UE 115-g may use for selective/dynamic out-of-order delivery of the SDUs. In some examples, the UE 115-g may begin a timer (e.g., the t-reordering timer) associated with a PDCP window based on a first SDU being absent from the PDCP window, and the UE 115-g may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-g may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-g may reduce the forwarding granularity of the PDCP layer, and the UE 115-g may reduce latency associated with the timer and the PDCP layer.

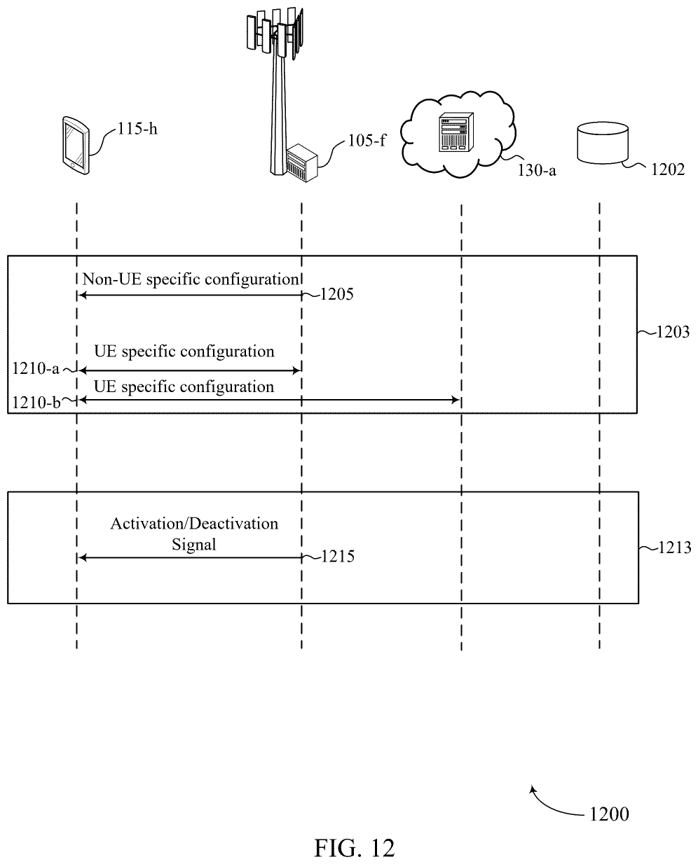

FIG. 12 shows an example of a process flow 1200 that supports selective SDU forwarding techniques in accordance with one or more aspects of the present disclosure. The process flow 1200 may implement aspects of the wireless communications system 100 and the wireless communications system 200, as described with reference to FIGS. 1 and 2, respectively. The process flow 1200 may include a UE 115-h and a network entity 105-f, which may be examples of UEs 115 and network entities 105 as described herein. Additionally, the process flow 1200 may include a repository 1202 (e.g., a database) storing one or more machine learning models, or information regarding the same. the repository 1202 may be an example of a repository 1102 described with reference to FIG. 11. In some aspects, the process flow 1200 may include a core network 130-a, which may be an example of the core network 130 described with reference to FIG. 1. In the following description of the process flow 1200, the operations between the UE 115-h, the network entity 105-f, the core network 130-a, and/or the repository 1202 may be transmitted in a different order than the example order shown, or the operations performed by the UE 115-h, the network entity 105-f, the core network 130-a, and/or the repository 1202 may be performed in different orders or at different times. Some operations may also be omitted from the process flow 1200, and other operations may be added to the process flow 1200.

In some examples, one or more of the UE 115-h, the network entity 105-f, or the core network 130-a may support performing one or more procedures 1203 and/or 1213, which may exchange of a set of one or more configurations (or a set of one or more parameters) associated with one or more learning models for AI/ML-enabled selective SDU forwarding. For example, one or more of the UE 115-h, the network entity 105-f, or the core network 130-a may support performing one or more procedures, which may exchange of the set of one or more configurations (or the set of one or more parameters) associated with the one or more learning models based at least in part on a state (e.g., an idle state, an inactivate state) of the UE 115-h. In some examples, one or more of the UE 115-h, the network entity 105-f, or the core network 130-a may support activating or deactivating the one or more learning models for inference during the state of the UE 115-h. For example, one or more of the UE 115-h, the network entity 105-f, or the core network 130-a may support activating or deactivating the one or more learning models to perform an inference (e.g., training) of the one or more learning models and cell selection, cell reselection, RLF recovery, measurement operations, random access channel operations (e.g., beam selection, random access channel occasions (RO), and the like).

At 1205, the network entity 105-f may transmit, and the UE 115-h may receive, a set of one or more non-UE specific configurations. For example, the network entity 105-f may broadcast, and the UE 115-h may receive, system information including the set of one or more non-UE specific configurations. The system information may include a system information block (SIB). The set of one or more non-UE specific configurations may include one or more sets of one or more parameters, which may be associated with a set of one or more learning models and include a set of one or more identifiers associated with the set of one or more learning models, etc.

Additionally, or alternatively, at 1210, the network entity 105-f may transmit, and the UE 115-h may receive, for example, via a unicast transmission, a set of one or more UE specific configurations for selective SDU forwarding techniques, as described herein. For example, the network entity 105-f may transmit, and the UE 115-h may receive, an RRC message including the set of one or more UE specific configurations. The set of one or more UE specific configurations may include one or more sets of one or more parameters, which may be associated with a set of one or more learning models including a set of one or more identifiers associated with the set of one or more learning models. In some examples, the RRC message may be an RRC release message during an RRC release procedure. In some examples, at 1210-a and/or 1210-b, one or more of the UE 115-h, the network entity 105-f, or the core network 130-a (e.g., one or more network functions associated with the core network 130-a) may exchange one or more NAS messages associated with the set of one or more UE specific configurations.

At 1215, the network entity 105-f may transmit, and the UE 115-h may receive, a signal (also referred to as an activation signal or a deactivation signal) for activating or deactivating one or more learning models. In some examples, the network entity 105-f may transmit, and the UE 115-h may receive, the signal for activating or deactivating the one or more learning models. For example, the network entity 105-f may transmit, and the UE 115-h may receive, a MAC-CE that activates or deactivates the one or more learning models and may perform an inference (e.g., training) of the one or more learning models during an idle state or an inactivate state of the UE 115-h. As such, activating or deactivating the one or more learning models may be based at least in part on the idle state or the inactivate state of the UE 115-h.

Accordingly, one or more of the UE 115-h, the network entity 105-f, or the core network 130-a may support activating or deactivating one or more learning models and for inference of the one or more learning models during an idle state or an inactivate state of the UE 115-h. For example, the UE 115-h may support techniques for dynamically and selectively forwarding SDUs, which may be based on aspects of the flow and/or priority associated with one or more SDUs. In such cases, the UE 115-h may use one or more ML models, which may be managed in accordance with the process flow 1200, for predicting one or more attributes associated with PDCP SDUs received by the UE 115-h. That is, the ML model may output one or more predictions about SDUs, which the UE 115-h may use for selective/dynamic out-of-order delivery of the SDUs. In some examples, the UE 115-h may begin a timer (e.g., the t-reordering timer) associated with a PDCP window based on a first SDU being absent from the PDCP window, and the UE 115-h may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-h may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-h may reduce the forwarding granularity of the PDCP layer, and the UE 115-h may reduce latency associated with the timer and the PDCP layer.

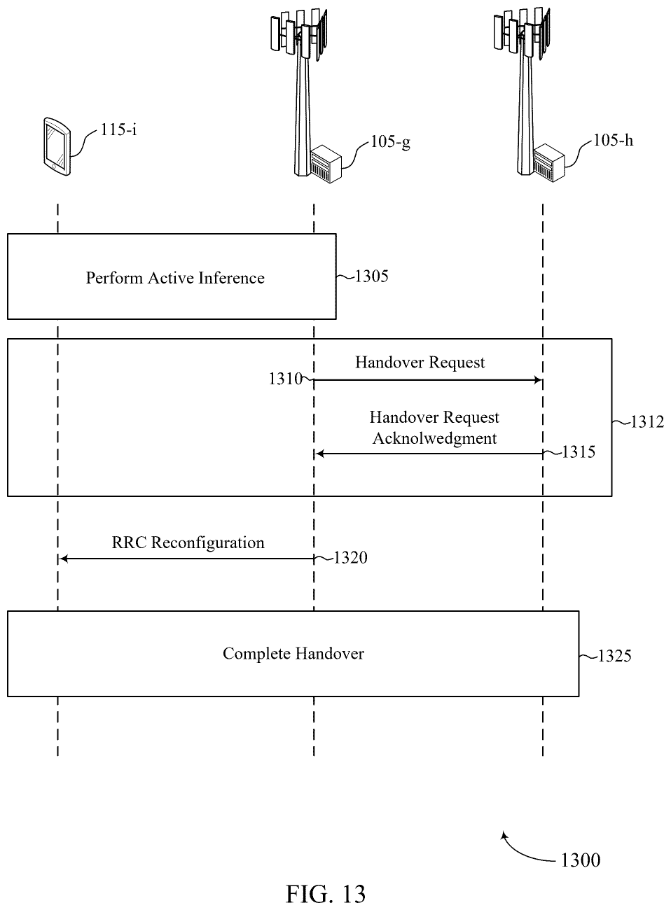

FIG. 13 shows an example of a process flow 1300 that supports selective SDU forwarding techniques in accordance with one or more aspects of the present disclosure. The process flow 1300 may implement aspects of the wireless communications system 100 and the wireless communications system 200, as described with reference to FIGS. 1 and 2, respectively. The process flow 1300 may include a UE 115-i, a network entity 105-g, and a network entity 105-h, which may be examples of UEs 115 and network entities 105 as described herein. In the following description of the process flow 1300, the operations between the UE 115-i, the network entity 105-g, and the network entity 105-h may be transmitted in a different order than the example order shown, or the operations performed by the UE 115-i, the network entity 105-g, and the network entity 105-h may be performed in different orders or at different times. Some operations may also be omitted from the process flow 1300, and other operations may be added to the process flow 1300.

In the example of FIG. 13, one or more of the UE 115-i, the network entity 105-g, and the network entity 105-h may support managing ML models for selective SDU forwarding during a mobility (also referred to as UE mobility) of the UE 115-i. More specifically, one or more of the UE 115-i, the network entity 105-g, and the network entity 105-h may support managing AI/ML functionality associated with the UE 115-i during a handover procedure, which may include switching (e.g., transferring) a connection of the UE 115-i from the network entity 105-g (also referred to as a source base station) to the network entity 105-h (also referred to as a target base station) and while maintaining ongoing AI/ML functionality.

At 1305, one or more of the UE 115-i or the network entity 105-g may perform an active inference (e.g., training) of one or more learning models. The inference (e.g., training) of the one or more learning models may be based at least in part on one or more sets of one or more configurations, including one or more sets of one or more parameters, configured by the network entity 105-g.

At 1310, the network entity 105-g may transmit, and the network entity 105-h may receive, a handover request message, which may include context information (e.g., AI/ML context) associated with the one or more ML models for AI/ML-enabled selective PDCP SDU delivery (e.g., dynamic out-of-order SDU delivery), which may occur during a handover preparation procedure 1312. At 1315, the network entity 105-h may transmit, and the network entity 105-g may receive, a handover request acknowledgment message during the handover preparation procedure 1312, which may include one or more sets of one or more configurations, including one or more sets of one or more parameters, configured by the network entity 105-h. Put another way, the network entity 105-h may provide a set of one or more AI/ML configurations for the UE 115-i to apply after being handed over to the network entity 105-h from the network entity 105-g. In some examples, the network entity 105-g may determine the sets of one or more configurations, including the one or more sets of one or more parameters, based at least in part on the context information (e.g., AI/ML context) received from the network entity 105-h. Additionally, or alternatively, the network entity 105-g may determine the sets of one or more configurations, including the one or more sets of one or more parameters, based at least in part on one or more of UE capabilities of the UE 115-i or network capabilities of the network entity 105-h. In some examples, one or more of the UE 115-i or the network entity 105-h may support partial or full AI/ML functionality (e.g., enabling of one or more features associated with at least one learning model).

At 1320, the network entity 105-g may transmit, and the UE 115-i may receive, an RRC reconfiguration message, which may include the sets of one or more configurations, including the one or more sets of one or more parameters, configured by the network entity 105-h. At 1325, one or more of the UE 115-i, the network entity 105-g, or the network entity 105-h may complete the handover procedure.

Accordingly, one or more of the UE 115-i, the network entity 105-g, or the network entity 105-h may support selective SDU forwarding for the UE 115-i using one or more ML models. For example, the UE 115-i may support techniques for dynamically and selectively forwarding SDUs, which may be based on aspects of the flow and/or priority associated with one or more SDUs. In such cases, the UE 115-i may use one or more ML models, which may be managed in accordance with the process flow 1300, for predicting one or more attributes associated with PDCP SDUs received by the UE 115-i. That is, the ML model may output one or more predictions about SDUs, which the UE 115-i may use for selective/dynamic out-of-order delivery of the SDUs. In some examples, the UE 115-i may begin a timer (e.g., the t-reordering timer) associated with a PDCP window based on a first SDU being absent from the PDCP window, and the UE 115-i may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-i may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-i may reduce the forwarding granularity of the PDCP layer, and the UE 115-i may reduce latency associated with the timer and the PDCP layer.

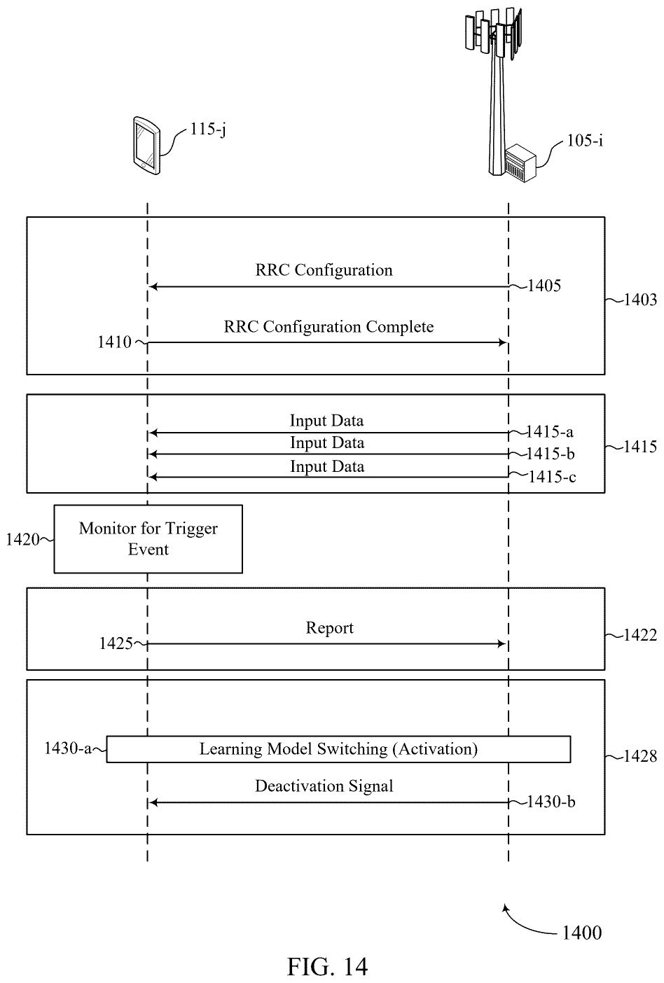

FIG. 14 shows an example of a process flow 1400 that supports selective SDU forwarding techniques in accordance with one or more aspects of the present disclosure. The process flow 1400 may implement aspects of the wireless communications system 100 and the wireless communications system 200, as described with reference to FIGS. 1 and 2, respectively. The process flow 1400 may include a UE 115-j and a network entity 105-i, which may be examples of UEs 115 and network entities 105 as described herein. In the following description of the process flow 1400, the operations between the UE 115-j and the network entity 105-i may be transmitted in a different order than the example order shown, or the operations performed by the UE 115-j and the network entity 105-i may be performed in different orders or at different times. Some operations may also be omitted from the process flow 1400, and other operations may be added to the process flow 1400.

In the example of FIG. 14, one or more of the UE 115-j or the network entity 105-i may support activating and deactivating one or more learning models based at least in part on reporting of feedback associated with the one or more learning models by the UE 115-j.

At 1405, the network entity 105-i may transmit, and the UE 115-j may receive, an RRC message that includes a set of one or more RRC configurations during a procedure 1403 (e.g., an RRC procedure), which may include a set of one or more parameters. In some examples, one or more parameters of the set of one or more parameters may include one or more performance KPIs or one or more system KPIs (e.g., as described herein with respect to FIG. 2), or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 1410, the UE 115-j may transmit, and the network entity 105-i may receive, an RRC configuration complete message e.g., during the procedure 1403.

At 1415, the network entity 105-i may transmit, and the UE 115-j may receive, input data, which may be input for one or more learning models at the UE 115-j. In some examples, the network entity 105-i may transmit, and the UE 115-j may receive, input data via one or more unicast transmissions. For example, at 1415-a, 1415-b, and 1415-c, the network entity 105-i may transmit, and the UE 115-j may receive, input data via one or more unicast transmissions. In some other examples, the network entity 105-i may broadcast, and the UE 115-j may receive, input data via one or more broadcast transmissions. For example, at 1415-a, 1415-b, and 1415-c, the network entity 105-i may transmit, and the UE 115-j may receive, input data via one or more broadcast transmissions.

At 1420, the UE 115-j may monitor for one or more events (e.g., threshold satisfied, conditions satisfied) associated with the one or more learning models. At 1425, the UE 115-j may transmit, and the network entity 105-i may receive, a report based at least in part on the one or more events, such as a reporting event 1422. The report may indicate the one or more performance KPIs or the one or more system KPIs, or a combination thereof.

At 1430-a, one or more of the UE 115-j or the network entity 105-i may switch between one or more learning models for AI/ML-enabled selective SDU forwarding as described herein, which may be based on one or more events, for example, associated with a procedure 1428 for switching, activation, or deactivation. For example, one or more of the UE 115-j or the network entity 105-i may active at least one learning model of the one or more learning models based at least in part on the reported one or more performance KPIs or the reported one or more system KPIs, or a combination thereof. Additionally, or alternatively, at 1430-b, one or more of the UE 115-j or the network entity 105-i may activate or deactivate at least one learning model of the one or more learning models based at least in part on the reported one or more performance KPIs or the reported one or more system KPIs, or a combination thereof.

Accordingly, one or more of the UE 115-j or the network entity 105-i may support activating and deactivating one or more learning models based at least in part on reported feedback associated with the one or more learning models by the UE 115-j. For example, the UE 115-j may support techniques for dynamically and selectively forwarding SDUs, which may be based on aspects of the flow and/or priority associated with one or more SDUs. In such cases, the UE 115-j may use one or more ML models, which may be managed in accordance with the process flow 1400, for predicting one or more attributes associated with PDCP SDUs received by the UE 115-j. That is, the ML model may output one or more predictions about SDUs, which the UE 115-j may use for selective/dynamic out-of-order delivery of the SDUs. In some examples, the UE 115-j may begin a timer (e.g., the t-reordering timer) associated with a PDCP window based on a first SDU being absent from the PDCP window, and the UE 115-j may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-j may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-j may reduce the forwarding granularity of the PDCP layer, and the UE 115-j may reduce latency associated with the timer and the PDCP layer.

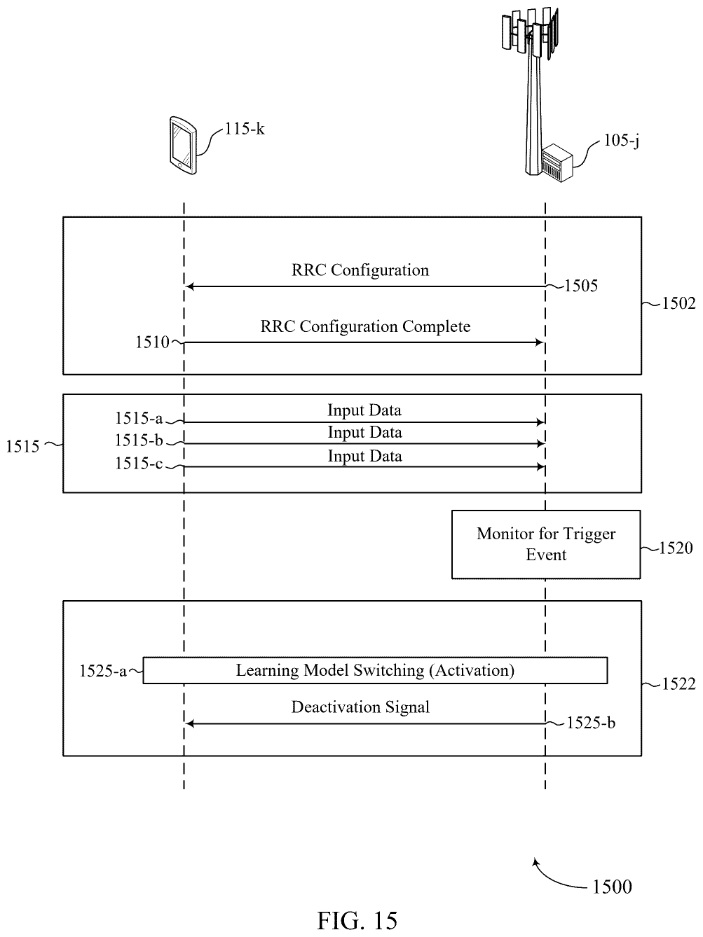

FIG. 15 shows an example of a process flow 1500 that supports selective SDU forwarding techniques in accordance with one or more aspects of the present disclosure. The process flow 1500 may implement aspects of the wireless communications system 100 and the wireless communications system 200, as described with reference to FIGS. 1 and 2, respectively. The process flow 1500 may include a UE 115-k and a network entity 105-j, which may be examples of UEs 115 and network entities 105 as described herein. In the following description of the process flow 1500, the operations between the UE 115-k and the network entity 105-j may be transmitted in a different order than the example order shown, or the operations performed by the UE 115-k and the network entity 105-j may be performed in different orders or at different times. Some operations may also be omitted from the process flow 1500, and other operations may be added to the process flow 1500.

In the example of FIG. 15, one or more of the UE 115-k or the network entity 105-j may support activating and deactivating one or more learning models based at least in part on monitoring by the network entity 105-j of the one or more learning models.

At 1505, the network entity 105-j may transmit, and the UE 115-k may receive, an RRC message that includes set of one or more RRC configurations during a procedure 1502 (e.g., an RRC procedure), which may include a set of one or more parameters. In some examples, one or more parameters of the set of one or more parameters may include one or more performance KPIs or one or more system KPIs, or a combination thereof. At 1510, the UE 115-k may transmit, and the network entity 105-j may receive, an RRC configuration complete message as part of the procedure 1502.

At 1515, the network entity 105-j may receive, and the UE 115-k may transmit, input data, which may be input for one or more learning models at the network entity 105-j. In some examples, the network entity 105-j may receive, and the UE 115-k may transmit, input data via one or more unicast transmissions. For example, at 1515-a, 1515-b, and 1515-c, the network entity 105-j may receive, and the UE 115-k may transmit, input data via one or more unicast transmissions. At 1520, the network entity 105-j may monitor for one or more events (e.g., threshold satisfied, conditions satisfied) associated with the one or more learning models at the network entity 105-j.

At 1525-a, one or more of the UE 115-k or the network entity 105-j may switch between one or more learning models based on one or more events, for example, associated with a procedure 1522 for switching, activation, or deactivation. For instance, one or more of the UE 115-k or the network entity 105-j may active at least one ML model of the one or more ML models based at least in part on the one or more events as described herein. Additionally, or alternatively, at 1525-b, one or more of the UE 115-k or the network entity 105-j may deactivate at least one ML model of the one or more ML models based on the one or more events as described herein. Accordingly, one or more of the UE 115-k or the network entity 105-j may support activating and deactivating one or more learning models to selectively forward SDUs at the UE 115-k based at least in part on monitoring by the network entity 105-j of the one or more learning models. For example, the UE 115-k may support techniques for dynamically and selectively forwarding SDUs, which may be based on aspects of the flow and/or priority associated with one or more SDUs. In such cases, the UE 115-k may use one or more ML models, which may be managed in accordance with the process flow 1400, for predicting one or more attributes associated with PDCP SDUs received by the UE 115-k. That is, the ML model may output one or more predictions about SDUs, which the UE 115-k may use for selective/dynamic out-of-order delivery of the SDUs. In some examples, the UE 115-k may begin a timer (e.g., the t-reordering timer) associated with a PDCP window based on a first SDU being absent from the PDCP window, and the UE 115-k may deliver (e.g., selectively deliver, selectively forward) a portion of a set of SDUs within the PDCP window to an upper protocol layer (e.g., another protocol layer of the protocol stack) before an expiration of the timer. For example, the portion may include one or more SDUs of the set of SDUs, and the UE 115-k may forward the portion based on a forwarding rule, as part of a forwarding sub-window (e.g., the sub-window being smaller than the PDCP window) of the PDCP window, or both. In some examples, the SDU that may be forwarded (e.g., out-of-order SDUs) before the timer expires may be predicted using one or more aspects of the ML model. Thus, the UE 115-k may reduce the forwarding granularity of the PDCP layer, and the UE 115-k may reduce latency associated with the timer and the PDCP layer.

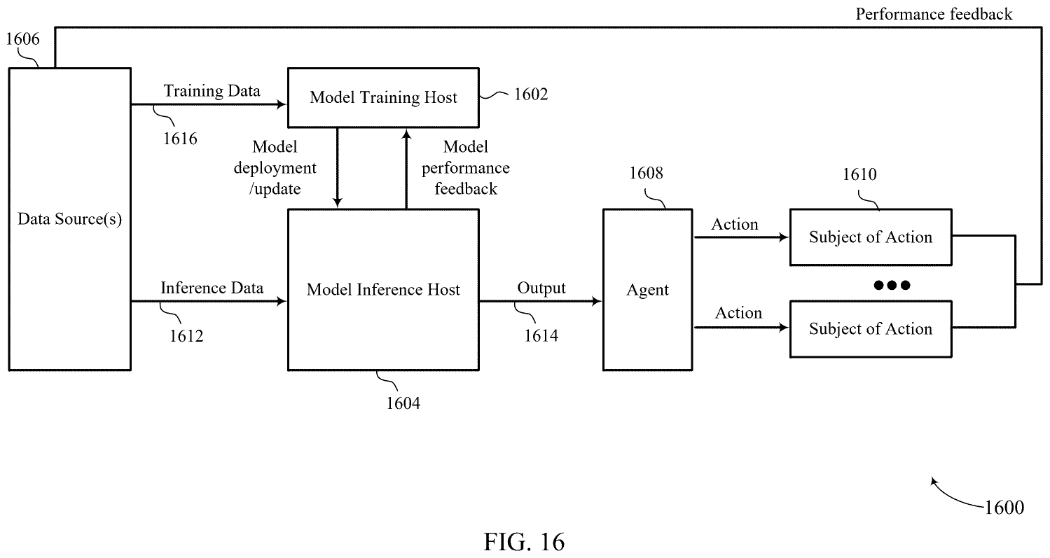

FIG. 16 shows an illustrative block diagram of an example ML architecture 1600 that may be used for wireless communications in accordance with one or more aspects of the present disclosure. The ML architecture 1600 may be used for wireless communications in any of the various implementations, processes, environments, networks, or use cases described herein. As illustrated, architecture 1600 includes multiple logical entities, such as model training host 1602, model inference host 1604, data source(s) 1606, and agent 1608. Model inference host 1604 is configured to run an ML model based on inference data 1612 provided by data source(s) 1606. Model inference host 1604 may produce output 1614, which may include a prediction or inference, such as a discrete or continuous value based on inference data 1612, which may then be provided as input to the agent 1608.

Agent 1608 may represent an element or an entity of a wireless communication system including, for example, a radio access network (RAN), a wireless local area network, a device-to-device (D2D) communications system, etc. As an example, agent 1608 may be a UE (e.g., UE 115 as described with reference to FIGS. 1 through 12 and 16 through 18), a base station (e.g., a base station 140 as described with reference to FIG. 1), or a disaggregated network entity (such as a CU, a DU, or a RU as described with reference to FIG. 1), an access point, a wireless station, a RIC in a cloud-based RAN, among some examples. Additionally, agent 1608 also may be a type of agent that depends on the type of tasks performed by model inference host 1604, the type of inference data 1612 provided to model inference host 1604, or the type of output 1614 produced by model inference host 1604.

Agent 1608 may perform one or more actions associated with receiving output 1614 from model inference host 1604. For example, if agent 1608 is a UE 115 and the output from model inference host 1604 is associated with selective SDU forwarding (e.g., predictions associated with SDUs in a PDCP forwarding window, as described herein with respect to FIGS. 3 and 4), the agent 1608 may selectively forward one or more SDUs based on output 1614.

Agent 1608 may indicate the one or more actions performed to at least one subject of action 1610. For example, if the agent 1608 selectively forwards one or more SDUs based on the output 1614, the agent 1608 may output an indication (e.g., the selectively forwarded SDUs) to the subject of action 1610 (e.g., one or more protocol layers of the UE 115 to which the agent 1608 selectively forwards the one or more SDUs).

As another example, agent 1608 may be a UE 115 and output 1614 from model inference host 1604 may include one or more characteristics of SDUs associated with selectively forwarding SDUs. For example, model inference host 1604 may predict a reordering domain of one or more SDUs, a relative priority level of one or more SDUs, a sub-window of SDUs associated with each other, one or more lost SDUs, or any combination thereof (e.g., or any other prediction described herein) based on data associated with SDUs in previous PDCP windows. Based on the predictions of the model inference host 1604, agent 1608 may forward one or more SDUs to the subject of action 1610 (such as, one or more protocol layers of the UE 115, as described with reference to FIG. 1). In some cases, agent 1608 and the subject of action 1610 are the same entity (e.g., or are within the same entity).

Data can be collected from data sources 1606, and may be used as training data 1616 for training an ML model, or as inference data 1612 for feeding an ML model inference operation. Data sources 1606 may collect data from various subject of action 1610 entities (such as, the UE 115 or the network entity 105), and provide the collected data to a model training host 1602 for ML model training. For example, after a subject of action 1610 (such as, a UE 115, a network entity 105, one or more protocol layers of the UE 115) obtains selectively forwarded SDUs from the agent 1608, the subject of action 1610 may provide performance feedback associated with the selectively forwarded SDUs (e.g., the selective forwarding information at 545 of FIG. 5) to the data sources 1606. The performance feedback may be used by the model training host 1602 for monitoring or evaluating the ML model performance. In some examples, if output 1614 provided to agent 1608 is inaccurate (or the accuracy is below an accuracy threshold), model training host 1602 may provide feedback to model inference host 1604 to modify or retrain the ML model used by model inference host 1604, such as via an ML model deployment/update.

Model training host 1602 may be deployed at the same or a different entity than that in which model inference host 1604 is deployed. For example, in order to offload model training processing, which can impact the performance of model inference host 1604, model training host 1602 may be deployed at a model server.

In some aspects, an ML model is deployed at or on a network entity (such as a base station 140 or a network entity 105) for supporting selective SDU forwarding within a PDCP window. In some other aspects, an ML model is deployed at or on a UE (such as UE 115) for supporting selective SDU forwarding. More specifically, a model inference host, such as model inference host 1604 in FIG. 16, may be deployed at or on the UE for predicting characteristics or features associated with one or more SDUs in a PDCP window, where the UE may use the predictions to selectively forward one or more SDUs (e.g., as described herein with respect to FIGS. 2-5).

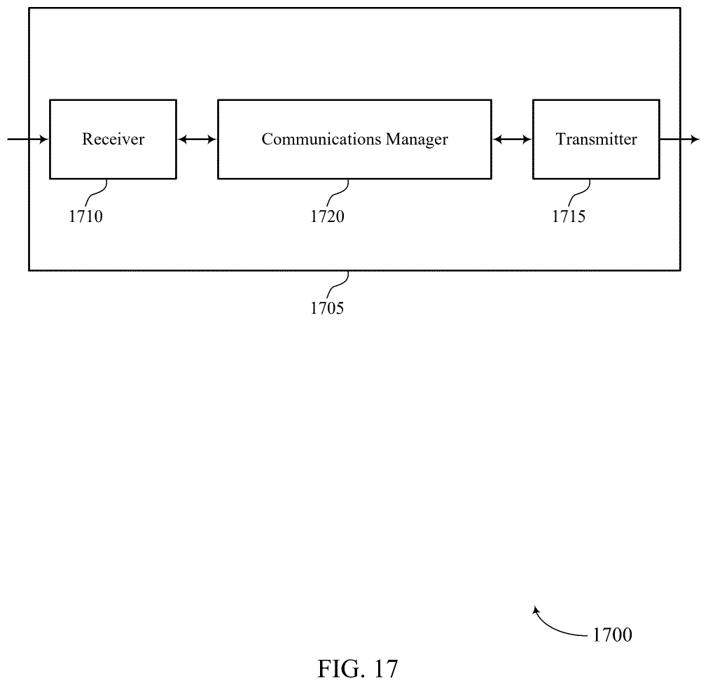

FIG. 17 shows a block diagram 1700 of a device 1705 that supports selective SDU forwarding techniques in accordance with one or more aspects of the present disclosure. The device 1705 may be an example of aspects of a UE 115 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to, individually or collectively, support or enable the described techniques. Each of these components may be in communication with one another (e.g., via one or more buses).

The receiver 1710 may provide a means for receiving information such as packets, user data, control information, or any combination thereof associated with various information channels (e.g., control channels, data channels, information channels related to selective SDU forwarding techniques). Information may be passed on to other components of the device 1705. The receiver 1710 may utilize a single antenna or a set of multiple antennas.

The transmitter 1715 may provide a means for transmitting signals generated by other components of the device 1705. For example, the transmitter 1715 may transmit information such as packets, user data, control information, or any combination thereof associated with various information channels (e.g., control channels, data channels, information channels related to selective SDU forwarding techniques). In some examples, the transmitter 1715 may be co-located with a receiver 1710 in a transceiver module. The transmitter 1715 may utilize a single antenna or a set of multiple antennas.

The communications manager 1720, the receiver 1710, the transmitter 1715, or various combinations or components thereof may be examples of means for performing various aspects of selective SDU forwarding techniques as described herein. For example, the communications manager 1720, the receiver 1710, the transmitter 1715, or various combinations or components thereof may be capable of performing one or more of the functions described herein.

In some examples, the communications manager 1720, the receiver 1710, the transmitter 1715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1720, the receiver 1710, the transmitter 1715, or various combinations or components thereof may be implemented in code (e.g., as communications management software or firmware) executed by at least one processor (e.g., referred to as a processor-executable code). If implemented in code executed by at least one processor, the functions of the communications manager 1720, the receiver 1710, the transmitter 1715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1720 may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications in accordance with examples as disclosed herein. For example, the communications manager 1720 is capable of, configured to, or operable to support a means for receiving a control message indicating one or more parameters associated with packet data convergence protocol (PDCP) reordering, where the one or more parameters include one or more ranges associated with at least one parameter of the one or more parameters, one or more performance parameters, or any combination thereof. The communications manager 1720 is capable of, configured to, or operable to support a means for processing a set of SDUs using a PDCP reordering window associated with a PDCP layer of a protocol stack of the UE. The communications manager 1720 is capable of, configured to, or operable to support a means for starting a timer based on a count of the set of SDUs indicating that at least one SDU is missing from the set of SDUs. The communications manager 1720 is capable of, configured to, or operable to support a means for delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

By including or configuring the communications manager 1720 in accordance with examples as described herein, the device 1705 (e.g., at least one processor controlling or otherwise coupled with the receiver 1710, the transmitter 1715, the communications manager 1720, or a combination thereof) may support techniques for reduced latency in processing SDUs associated with the PDCP layer of the protocol stack. For example, a UE that implements the techniques described herein may deliver SDUs from the PDCP layer before an expiration of a timer (e.g., reordering timer) associated with the PDCP layer, which may reduce latency associated with processing the SDUs.

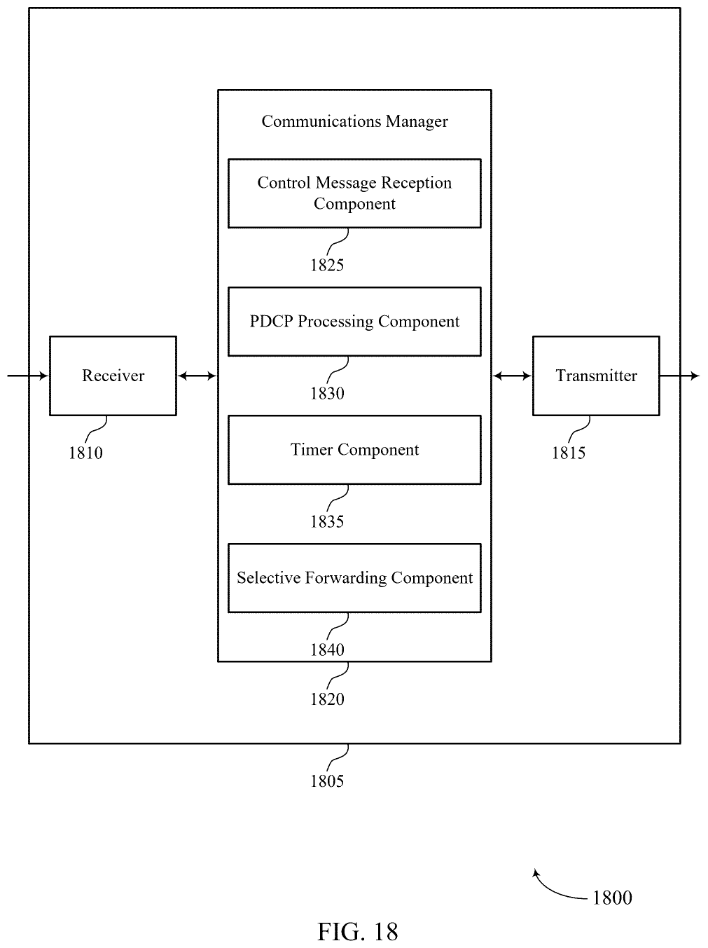

FIG. 18 shows a block diagram 1800 of a device 1805 that supports selective SDU forwarding techniques in accordance with one or more aspects of the present disclosure. The device 1805 may be an example of aspects of a device 1705 or a UE 115 as described herein. The device 1805 may include a receiver 1810, a transmitter 1815, and a communications manager 1820. The device 1805, or one or more components of the device 1805 (e.g., the receiver 1810, the transmitter 1815, the communications manager 1820), may include at least one processor, which may be coupled with at least one memory, to support the described techniques. Each of these components may be in communication with one another (e.g., via one or more buses).

The receiver 1810 may provide a means for receiving information such as packets, user data, control information, or any combination thereof associated with various information channels (e.g., control channels, data channels, information channels related to selective SDU forwarding techniques). Information may be passed on to other components of the device 1805. The receiver 1810 may utilize a single antenna or a set of multiple antennas.

The transmitter 1815 may provide a means for transmitting signals generated by other components of the device 1805. For example, the transmitter 1815 may transmit information such as packets, user data, control information, or any combination thereof associated with various information channels (e.g., control channels, data channels, information channels related to selective SDU forwarding techniques). In some examples, the transmitter 1815 may be co-located with a receiver 1810 in a transceiver module. The transmitter 1815 may utilize a single antenna or a set of multiple antennas.

The device 1805, or various components thereof, may be an example of means for performing various aspects of selective SDU forwarding techniques as described herein. For example, the communications manager 1820 may include a control message reception component 1825, a PDCP processing component 1830, a timer component 1835, a selective forwarding component 1840, or any combination thereof. The communications manager 1820 may be an example of aspects of a communications manager 1720 as described herein. In some examples, the communications manager 1820, or various components thereof, may be configured to perform various operations (e.g., receiving, obtaining, monitoring, outputting, transmitting) using or otherwise in cooperation with the receiver 1810, the transmitter 1815, or both. For example, the communications manager 1820 may receive information from the receiver 1810, send information to the transmitter 1815, or be integrated in combination with the receiver 1810, the transmitter 1815, or both to obtain information, output information, or perform various other operations as described herein.

The communications manager 1820 may support wireless communications in accordance with examples as disclosed herein. The control message reception component 1825 is capable of, configured to, or operable to support a means for receiving a control message indicating one or more parameters associated with packet data convergence protocol (PDCP) reordering, where the one or more parameters include one or more ranges associated with at least one parameter of the one or more parameters, one or more performance parameters, or any combination thereof. The PDCP processing component 1830 is capable of, configured to, or operable to support a means for processing a set of SDUs using a PDCP reordering window associated with a PDCP layer of a protocol stack of the UE. The timer component 1835 is capable of, configured to, or operable to support a means for starting a timer based on a count of the set of SDUs indicating that at least one SDU is missing from the set of SDUs. The selective forwarding component 1840 is capable of, configured to, or operable to support a means for delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

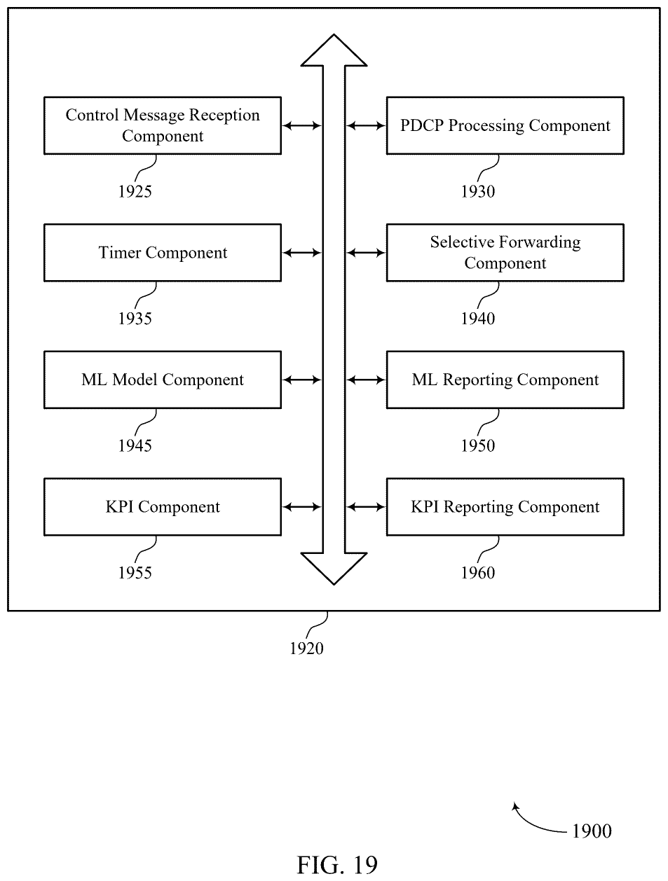

FIG. 19 shows a block diagram 1900 of a communications manager 1920 that supports selective SDU forwarding techniques in accordance with one or more aspects of the present disclosure. The communications manager 1920 may be an example of aspects of a communications manager 1720, a communications manager 1820, or both, as described herein. The communications manager 1920, or various components thereof, may be an example of means for performing various aspects of selective SDU forwarding techniques as described herein. For example, the communications manager 1920 may include a control message reception component 1925, a PDCP processing component 1930, a timer component 1935, a selective forwarding component 1940, an ML model component 1945, an ML reporting component 1950, a KPI component 1955, a KPI reporting component 1960, or any combination thereof. Each of these components, or components or subcomponents thereof (e.g., one or more processors, one or more memories), may communicate, directly or indirectly, with one another (e.g., via one or more buses).

The communications manager 1920 may support wireless communications in accordance with examples as disclosed herein. The control message reception component 1925 is capable of, configured to, or operable to support a means for receiving a control message indicating one or more parameters associated with packet data convergence protocol (PDCP) reordering, where the one or more parameters include one or more ranges associated with at least one parameter of the one or more parameters, one or more performance parameters, or any combination thereof. The PDCP processing component 1930 is capable of, configured to, or operable to support a means for processing a set of SDUs using a PDCP reordering window associated with a PDCP layer of a protocol stack of the UE. The timer component 1935 is capable of, configured to, or operable to support a means for starting a timer based on a count of the set of SDUs indicating that at least one SDU is missing from the set of SDUs. The selective forwarding component 1940 is capable of, configured to, or operable to support a means for delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

In some examples, the selective forwarding component 1940 is capable of, configured to, or operable to support a means for determining, based on one or more predictions associated with the set of SDUs, whether to deliver the one or more SDUs out-of-order with respect to other SDUs of the set of SDUs in accordance with the forwarding rule, where the one or more SDUs are delivered to the upper layer in accordance with the determination.

In some examples, the one or more predictions include a prediction of respective flows associated with each service data unit of the set of service data units, and to support delivering the portion, the selective forwarding component 1940 is capable of, configured to, or operable to support a means for delivering the one or more SDUs based on the prediction indicating that the one or more SDUs are associated with a same flow.

In some examples, the one or more predictions include a prediction of one or more attributes associated with each service data unit of the set of service data units, and to support delivering the portion, the selective forwarding component 1940 is capable of, configured to, or operable to support a means for delivering the one or more SDUs based on the prediction indicating that the one or more SDUs are associated with a first attribute of the one or more attributes for forwarding the one or more SDUs to the upper layer before the timer expires, a second attribute for reordering the set of SDUs, or both.

In some examples, the one or more attributes include a transport control protocol acknowledgment, a packet delay budget parameter, a latency parameter, a correspondence to one or more previously-delivered SDUs, a correspondence to a quality of service flow, one or more application parameters, or any combination thereof.

In some examples, the one or more predictions include a prediction of a priority associated with each service data unit of the set of service data units, and to support delivering the portion, the selective forwarding component 1940 is capable of, configured to, or operable to support a means for delivering the one or more SDUs based on the prediction indicating that a priority of the one or more SDUs is associated with forwarding the one or more SDUs to the upper layer before the timer expires.

In some examples, the selective forwarding component 1940 is capable of, configured to, or operable to support a means for determining a size of the forwarding sub-window based on a prediction of the at least one SDU missing from the set of SDUs and one or more SDUs that have not yet been included in the PDCP reordering window, where the one or more SDUs are delivered to the upper layer based on the size of the forwarding sub-window.

In some examples, the timer continues to run after the one or more SDUs are delivered to the upper layer before the timer expires in accordance with the forwarding sub-window.

In some examples, the selective forwarding component 1940 is capable of, configured to, or operable to support a means for determining that the size of the forwarding sub-window is at least equal to a size of the PDCP reordering window. In some examples, the selective forwarding component 1940 is capable of, configured to, or operable to support a means for delivering the set of SDUs associated with the PDCP reordering window. In some examples, the timer component 1935 is capable of, configured to, or operable to support a means for stopping the timer.

In some examples, the portion of the set of SDUs that is delivered include one or more received and buffered SDUs.

In some examples, the ML model component 1945 is capable of, configured to, or operable to support a means for identifying one or more features associated with a ML model used for predicting the one or more SDUs to be delivered to the upper layer in accordance with the forwarding rule, as part of the forwarding sub-window of the PDCP reordering window, or both, the one or more features including flow detection, protocol data unit set detection, packet type detection, latency sensitivity detection, priority detection, detection of a correspondence between respective SDUs, arrival latency detection, predicted failure detection, or any combination thereof, where delivering the portion of the set of SDUs is based on the one or more features, and predicting, using the machine learning model and based at least in part on the one or more features, the one or more service data units to be delivered to the upper layer in accordance with the forwarding rule, as part of the forwarding sub-window of the PDCP reordering window, or both.

In some examples, the ML reporting component 1950 is capable of, configured to, or operable to support a means for transmitting a message including information that indicates SDUs that have been delivered to the upper layer, the information including an indication of SDUs that were delivered in order, an indication of SDUs delivered out-of-order based on the timer expiring, an indication of SDUs delivered out-of-order in accordance with the forwarding rule, an indication of SDUs delivered out-of-order as part of the forwarding sub-window of the PDCP reordering window, or any combination thereof.

In some examples, the ML reporting component 1950 is capable of, configured to, or operable to support a means for transmitting a message including an indication of a reordering policy used by the UE for delivering the portion of the set of SDUs to the upper layer, the reordering policy indicating one or more second parameters used for forwarding the one or more SDUs out-of-order with respect to other SDUs of the set of SDUs.

In some examples, the ML reporting component 1950 is capable of, configured to, or operable to support a means for transmitting a message indicating information associated with the set of SDUs, where the information includes an indication of a predicted arrival time of the one or more SDUs, an indication of the one or more SDUs that are forwarded out-of-order with respect to other SDUs of the set of SDUs, an indication of the set of SDUs that are delivered in-order, an indication of a value of the timer when the portion is delivered to the upper layer, an indication of a value of the count when the portion is delivered to the upper layer, an indication of respective index values of the set of SDUs, an indication of a difference between a predicted arrival time of a first SDU of the set of SDUs and an actual arrival time of the first SDU, an indication of a frequency of satisfying the one or more KPIs, or any combination thereof.

In some examples, the ML reporting component 1950 is capable of, configured to, or operable to support a means for transmitting a capability message indicating a capability of the UE to support delivering the portion of the set of SDUs, an accuracy of a ML model with respect to one or more predictions, or both, where the one or more predictions include one or more predicted attributes of a buffered SDU, one or more predicted attributes of a SDU that has not yet arrived, a predicted arrival time of respective SDUs of the set of SDUs, or any combination thereof.

In some examples, the control message reception component 1925 is capable of, configured to, or operable to support a means for receiving a second control message indicating a configuration of one or more reordering parameters associated with reordering the set of SDUs, or delivering the portion of the set of SDUs in accordance with the forwarding rule, or both, where delivering the one or more SDUs in accordance with the forwarding rule is based on the configuration.

In some examples, the one or more reordering parameters include a first threshold duration of the timer before delivering the one or more SDUs, a second threshold duration of the timer for delivering the one or more SDUs, a set of attributes for forwarding the one or more SDUs, a threshold quantity of SDUs that are allowed to be forwarded before the timer expires, a threshold quantity of SDUs per set of attributes that are allowed to be delivered out-of-order with respect to other SDUs, a second timer associated with a duration, an indication of whether use of a ML model is allowed for delivering the set of SDUs, an indication of whether forwarding the one or more SDUs in accordance with the forwarding rule is allowed, or any combination thereof.

In some examples, the control message reception component 1925 is capable of, configured to, or operable to support a means for receiving a control message indicating a configuration of one or more reordering parameters, where the one or more reordering parameters are associated with delivering the portion of the set of SDUs as part of the forwarding sub-window of the PDCP reordering window, and where delivering the one or more SDUs as part of the forwarding sub-window of the PDCP reordering window is based on the configuration.

In some examples, the one or more reordering parameters include a threshold duration of the timer before delivering the one or more SDUs, a threshold quantity of SDUs that are allowed to be forwarded before the timer expires, a second timer associated with a duration, an indication of whether delivery using the forwarding sub-window is allowed, or any combination thereof.

In some examples, the control message reception component 1925 is capable of, configured to, or operable to support a means for receiving a control message including an indication of one or more KPIs associated with the PDCP reordering window, where delivering the portion of the set of SDUs is based on the one or more KPIs.

In some examples, the KPI component 1955 is capable of, configured to, or operable to support a means for determining that the one or more KPIs fail to be satisfied based on delivering the portion of the set of SDUs. In some examples, the selective forwarding component 1940 is capable of, configured to, or operable to support a means for delivering, from the PDCP layer to the upper layer of the protocol stack, a second set of SDUs based on an expiration of the timer and the one or more KPIs failing to be satisfied.

In some examples, the KPI component 1955 is capable of, configured to, or operable to support a means for determining that the one or more KPIs fail to be satisfied based on delivering the portion of the set of SDUs. In some examples, the KPI reporting component 1960 is capable of, configured to, or operable to support a means for transmitting a report message including an indication that the one or more KPIs fail to be satisfied based on the one or more KPIs failing to be satisfied.

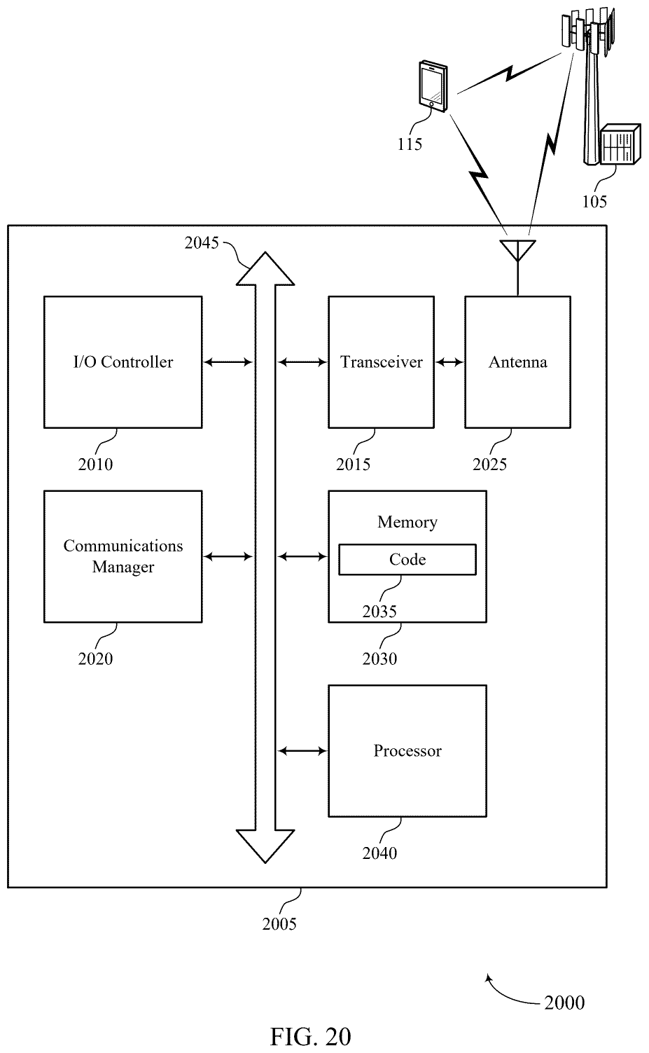

FIG. 20 shows a diagram of a system 2000 including a device 2005 that supports selective SDU forwarding techniques in accordance with one or more aspects of the present disclosure. The device 2005 may be an example of or include components of a device 1705, a device 1805, or a UE 115 as described herein. The device 2005 may communicate (e.g., wirelessly) with one or more other devices (e.g., network entities 105, UEs 115, or a combination thereof). The device 2005 may include components for bi-directional voice and data communications including components for transmitting and receiving communications, such as a communications manager 2020, an input/output (I/O) controller, such as an I/O controller 2010, a transceiver 2015, one or more antennas 2025, at least one memory 2030, code 2035, and at least one processor 2040. These components may be in electronic communication or otherwise coupled (e.g., operatively, communicatively, functionally, electronically, electrically) via one or more buses (e.g., a bus 2045).

The I/O controller 2010 may manage input and output signals for the device 2005. The I/O controller 2010 may also manage peripherals not integrated into the device 2005. In some cases, the I/O controller 2010 may represent a physical connection or port to an external peripheral. In some cases, the I/O controller 2010 may utilize an operating system such as iOS®, ANDROID®, MS-DOS®, MS-WINDOWS®, OS/2®, UNIX®, LINUX®, or another known operating system. Additionally, or alternatively, the I/O controller 2010 may represent or interact with a modem, a keyboard, a mouse, a touchscreen, or a similar device. In some cases, the I/O controller 2010 may be implemented as part of one or more processors, such as the at least one processor 2040. In some cases, a user may interact with the device 2005 via the I/O controller 2010 or via hardware components controlled by the I/O controller 2010.

In some cases, the device 2005 may include a single antenna. However, in some other cases, the device 2005 may have more than one antenna, which may be capable of concurrently transmitting or receiving multiple wireless transmissions. The transceiver 2015 may communicate bi-directionally via the one or more antennas 2025 using wired or wireless links as described herein. For example, the transceiver 2015 may represent a wireless transceiver and may communicate bi-directionally with another wireless transceiver. The transceiver 2015 may also include a modem to modulate the packets, to provide the modulated packets to one or more antennas 2025 for transmission, and to demodulate packets received from the one or more antennas 2025. The transceiver 2015, or the transceiver 2015 and one or more antennas 2025, may be an example of a transmitter 1715, a transmitter 1815, a receiver 1710, a receiver 1810, or any combination thereof or component thereof, as described herein.

The at least one memory 2030 may include random access memory (RAM) and read-only memory (ROM). The at least one memory 2030 may store computer-readable, computer-executable, or processor-executable code, such as the code 2035. The code 2035 may include instructions that, when executed by the at least one processor 2040, cause the device 2005 to perform various functions described herein. The code 2035 may be stored in a non-transitory computer-readable medium such as system memory or another type of memory. In some cases, the code 2035 may not be directly executable by the at least one processor 2040 but may cause a computer (e.g., when compiled and executed) to perform functions described herein. In some cases, the at least one memory 2030 may include, among other things, a basic I/O system (BIOS) which may control basic hardware or software operation such as the interaction with peripheral components or devices.

The at least one processor 2040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 2040 may be configured to operate a memory array using a memory controller. In some other cases, a memory controller may be integrated into the at least one processor 2040. The at least one processor 2040 may be configured to execute computer-readable instructions stored in a memory (e.g., the at least one memory 2030) to cause the device 2005 to perform various functions (e.g., functions or tasks supporting selective SDU forwarding techniques). For example, the device 2005 or a component of the device 2005 may include at least one processor 2040 and at least one memory 2030 coupled with or to the at least one processor 2040, the at least one processor 2040 and the at least one memory 2030 configured to perform various functions described herein.

In some examples, the at least one processor 2040 may include multiple processors and the at least one memory 2030 may include multiple memories. One or more of the multiple processors may be coupled with one or more of the multiple memories, which may, individually or collectively, be configured to perform various functions described herein. In some examples, the at least one processor 2040 may be a component of a processing system, which may refer to a system (such as a series) of machines, circuitry (including, for example, one or both of processor circuitry (which may include the at least one processor 2040) and memory circuitry (which may include the at least one memory 2030)), or components, that receives or obtains inputs and processes the inputs to produce, generate, or obtain a set of outputs. The processing system may be configured to perform one or more of the functions described herein. For example, the at least one processor 2040 or a processing system including the at least one processor 2040 may be configured to, configurable to, or operable to cause the device 2005 to perform one or more of the functions described herein. Further, as described herein, being “configured to,” being “configurable to,” and being “operable to” may be used interchangeably and may be associated with a capability, when executing code 2035 (e.g., processor-executable code) stored in the at least one memory 2030 or otherwise, to perform one or more of the functions described herein.

The communications manager 2020 may support wireless communications in accordance with examples as disclosed herein. For example, the communications manager 2020 is capable of, configured to, or operable to support a means for receiving a control message indicating one or more parameters associated with packet data convergence protocol (PDCP) reordering, where the one or more parameters include one or more ranges associated with at least one parameter of the one or more parameters, one or more performance parameters, or any combination thereof. The communications manager 2020 is capable of, configured to, or operable to support a means for processing a set of SDUs using a PDCP reordering window associated with a PDCP layer of a protocol stack of the UE. The communications manager 2020 is capable of, configured to, or operable to support a means for starting a timer based on a count of the set of SDUs indicating that at least one SDU is missing from the set of SDUs. The communications manager 2020 is capable of, configured to, or operable to support a means for delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters.

By including or configuring the communications manager 2020 in accordance with examples as described herein, the device 2005 may support techniques for reduced latency at a UE. For example, a UE that implements the techniques described herein may deliver SDUs from the PDCP layer before an expiration of a timer (e.g., reordering timer) associated with the PDCP layer, which may reduce latency associated with processing the SDUs.

In some examples, the communications manager 2020 may be configured to perform various operations (e.g., receiving, monitoring, transmitting) using or otherwise in cooperation with the transceiver 2015, the one or more antennas 2025, or any combination thereof. Although the communications manager 2020 is illustrated as a separate component, in some examples, one or more functions described with reference to the communications manager 2020 may be supported by or performed by the at least one processor 2040, the at least one memory 2030, the code 2035, or any combination thereof. For example, the code 2035 may include instructions executable by the at least one processor 2040 to cause the device 2005 to perform various aspects of selective SDU forwarding techniques as described herein, or the at least one processor 2040 and the at least one memory 2030 may be otherwise configured to, individually or collectively, perform or support such operations.

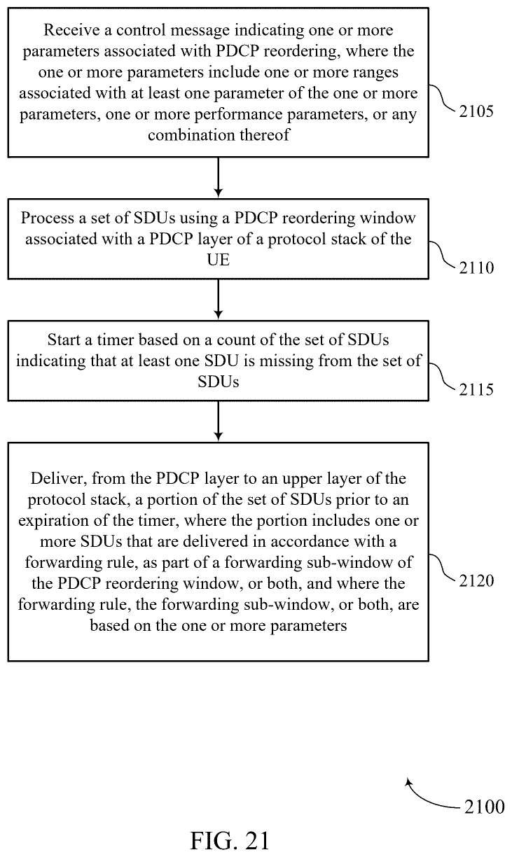

FIG. 21 shows a flowchart illustrating a method 2100 that supports selective SDU forwarding techniques in accordance with one or more aspects of the present disclosure. The operations of the method 2100 may be implemented by a UE or its components as described herein. For example, the operations of the method 2100 may be performed by a UE 115 as described with reference to FIGS. 1 through 20. In some examples, a UE may execute a set of instructions to control the functional elements of the UE to perform the described functions. Additionally, or alternatively, the UE may perform aspects of the described functions using special-purpose hardware.

At 2105, the method may include receiving a control message indicating one or more parameters associated with packet data convergence protocol (PDCP) reordering, where the one or more parameters include one or more ranges associated with at least one parameter of the one or more parameters, one or more performance parameters, or any combination thereof. The operations of 2105 may be performed in accordance with examples as disclosed herein. For example, the one or more parameters may be further described herein with respect to FIG. 2, and a UE 115 may receive the one or more parameters from a network entity 105. In some examples, aspects of the operations of 2105 may be performed by a control message reception component 1925 of a UE 115 as described with reference to FIGS. 1 and 19.

At 2110, the method may include processing a set of SDUs using a PDCP reordering window associated with a PDCP layer of a protocol stack of the UE. The operations of 2110 may be performed in accordance with examples as disclosed herein. In some examples, aspects of the operations of 2110 may be performed by a PDCP processing component 1930 of a UE 115, as described with reference to FIGS. 1 and 19.

At 2115, the method may include starting a timer based on a count of the set of SDUs indicating that at least one SDU is missing from the set of SDUs. The operations of 2115 may be performed in accordance with examples as disclosed herein. In some examples, aspects of the operations of 2115 may be performed by a timer component 1935 of a UE 115 as described with reference to FIGS. 1 and 19.

At 2120, the method may include delivering, from the PDCP layer to an upper layer of the protocol stack, a portion of the set of SDUs prior to an expiration of the timer, where the portion includes one or more SDUs that are delivered in accordance with a forwarding rule, as part of a forwarding sub-window of the PDCP reordering window, or both, and where the forwarding rule, the forwarding sub-window, or both, are based on the one or more parameters. The operations of 2120 may be performed in accordance with examples as disclosed herein. In some examples, aspects of the operations of 2120 may be performed by a selective forwarding component 1940 of a UE 115 as described with reference to FIGS. 1 and 19.

The following provides an overview of aspects of the present disclosure:
Aspect 1: A method for wireless communications at a UE, comprising: receiving a control message that indicates one or more parameters associated with PDCP reordering, wherein the one or more parameters include one or more ranges associated with at least one parameter of the one or more parameters, one or more performance parameters, or any combination thereof; processing a set of SDUs via a PDCP reordering window associated with a PDCP layer of a protocol stack of the UE; starting a timer based at least in part on a count of the set of SDUs that indicates that at least one SDU is missing from the set of SDUs; and delivering, from the PDCP layer to an upper layer of the protocol stack, a portion of the set of SDUs prior to an expiration of the timer, wherein the portion comprises one or more SDUs that are delivered in accordance with a forwarding rule, as part of a forwarding sub-window of the PDCP reordering window, or both, and wherein the forwarding rule, the forwarding sub-window, or both, are based at least in part on the one or more parameters.
Aspect 2: The method of aspect 1, further comprising: determining, based at least in part on one or more predictions associated with the set of SDUs, whether to deliver the one or more SDUs out-of-order with respect to other SDUs of the set of SDUs in accordance with the forwarding rule, wherein the one or more SDUs are delivered to the upper layer in accordance with the determination.
Aspect 3: The method of aspect 2, wherein the one or more predictions include a prediction of respective flows associated with each SDU of the set of SDUs, wherein delivering the portion comprises: delivering the one or more SDUs based at least in part on the prediction that indicates that the one or more SDUs are associated with a same flow.
Aspect 4: The method of aspect 2, wherein the one or more predictions include a prediction of one or more attributes associated with each SDU of the set of SDUs, wherein delivering the portion comprises: delivering the one or more SDUs based at least in part on the prediction that indicates that the one or more SDUs are associated with a first attribute of the one or more attributes to forward the one or more SDUs to the upper layer before the timer expires, a second attribute to reorder the set of SDUs, or both.
Aspect 5: The method of aspect 4, wherein the one or more attributes comprise a transport control protocol acknowledgment, a packet delay budget parameter, a latency parameter, a correspondence to one or more previously-delivered SDUs, a correspondence to a quality of service flow, one or more application parameters, or any combination thereof.
Aspect 6: The method of aspect 2, wherein the one or more predictions include a prediction of a priority associated with each SDU of the set of SDUs, wherein delivering the portion comprises: delivering the one or more SDUs based at least in part on the prediction that indicates that a priority of the one or more SDUs indicates that the one or more SDUs are to be forwarded to the upper layer before the timer expires.
Aspect 7: The method of aspect 1, further comprising: determining a size of the forwarding sub-window based at least in part on a prediction of the at least one SDU missing from the set of SDUs and one or more SDUs that have not yet been included in the PDCP reordering window, wherein the one or more SDUs are delivered to the upper layer based at least in part on the size of the forwarding sub-window.
Aspect 8: The method of aspect 7, wherein the timer continues to run after the one or more SDUs are delivered to the upper layer before the timer expires in accordance with the forwarding sub-window.
Aspect 9: The method of aspect 7, further comprising: determining that the size of the forwarding sub-window is at least equal to a size of the PDCP reordering window; delivering the set of SDUs associated with the PDCP reordering window; and stopping the timer.
Aspect 10: The method of any of aspects 1 through 9, wherein the portion of the set of SDUs that is delivered comprise one or more received and buffered SDUs.
Aspect 11: The method of any of aspects 1 through 10, further comprising: identifying one or more features associated with a ML model used for predictions of the one or more SDUs to be delivered to the upper layer in accordance with the forwarding rule, as part of the forwarding sub-window of the PDCP reordering window, or both, the one or more features comprising flow detection, PDU set detection, packet type detection, latency sensitivity detection, priority detection, detection of a correspondence between respective SDUs, arrival latency detection, predicted failure detection, or any combination thereof, wherein the portion of the set of SDUs is delivered based at least in part on the one or more features; and predicting, using the machine learning model and based at least in part on the one or more features, the one or more service data units to be delivered to the upper layer in accordance with the forwarding rule, as part of the forwarding sub-window of the PDCP reordering window, or both.
Aspect 12: The method of any of aspects 1 through 6, 10, and 11, further comprising: transmitting a message comprising information that indicates SDUs that have been delivered to the upper layer, the information comprising an indication of SDUs that were delivered in order, an indication of SDUs delivered out-of-order based at least in part on an expiration of the timer, an indication of SDUs delivered out-of-order in accordance with the forwarding rule, an indication of SDUs delivered out-of-order as part of the forwarding sub-window of the PDCP reordering window, or any combination thereof.
Aspect 13: The method of any of aspects 1 through 6 and 10 through 12, further comprising: transmitting a message comprising an indication of a reordering policy used by the UE to deliver the portion of the set of SDUs to the upper layer, the reordering policy indicates one or more second parameters used for the one or more SDUs delivered out-of-order with respect to other SDUs of the set of SDUs.
Aspect 14: The method of any of aspects 7 through 9, 10, and 11, further comprising: transmitting a message that indicates information associated with the set of SDUs, wherein the information comprises an indication of a predicted arrival time of the one or more SDUs, an indication of the one or more SDUs that are forwarded out-of-order with respect to other SDUs of the set of SDUs, an indication of the set of SDUs that are delivered in-order, an indication of a value of the timer when the portion is delivered to the upper layer, an indication of a value of the count when the portion is delivered to the upper layer, an indication of respective index values of the set of SDUs, an indication of a difference between a predicted arrival time of a first SDU of the set of SDUs and an actual arrival time of the first SDU, an indication of a frequency of satisfying one or more KPIs, or any combination thereof.
Aspect 15: The method of any of aspects 1 through 14, further comprising: transmitting a capability message that indicates a capability of the UE to support delivery of the portion of the set of SDUs, an accuracy of a ML model with respect to one or more predictions, or both, wherein the one or more predictions comprise one or more predicted attributes of a buffered SDU, one or more predicted attributes of a SDU that has not yet arrived, a predicted arrival time of respective SDUs of the set of SDUs, or any combination thereof.
Aspect 16: The method of any of aspects 1 through 6, 10 through 12, and 15, further comprising: receiving a second control message that indicates a configuration of one or more reordering parameters used to reorder the set of SDUs, or to deliver the portion of the set of SDUs in accordance with the forwarding rule, or both, wherein the one or more SDUs are delivered in accordance with the forwarding rule is based at least in part on the configuration.
Aspect 17: The method of aspect 16, wherein the one or more reordering parameters comprise a first threshold duration of the timer before the one or more SDUs are delivered, a second threshold duration of the timer to deliver the one or more SDUs, a set of attributes used to forward the one or more SDUs, a threshold quantity of SDUs that are allowed to be forwarded before the timer expires, a threshold quantity of SDUs per set of attributes that are allowed to be delivered out-of-order with respect to other SDUs, a second timer associated with a duration, an indication of whether use of a ML model is allowed to deliver the set of SDUs, an indication of whether the one or more SDUs are to be delivered in accordance with the forwarding rule, or any combination thereof.
Aspect 18: The method of any of aspects 7 through 9 and 14 through 15, further comprising: receiving a control message that indicates a configuration of one or more reordering parameters, wherein the one or more reordering parameters are used to deliver the portion of the set of SDUs as part of the forwarding sub-window of the PDCP reordering window, and wherein the one or more SDUs are delivered as part of the forwarding sub-window of the PDCP reordering window based at least in part on the configuration.
Aspect 19: The method of aspect 18, wherein the one or more reordering parameters comprise a threshold duration of the timer before delivering the one or more SDUs, a threshold quantity of SDUs that are allowed to be forwarded before the timer expires, a second timer associated with a duration, an indication of whether delivery using the forwarding sub-window is allowed, or any combination thereof.
Aspect 20: The method of any of aspects 1 through 19, further comprising: receiving a control message comprising an indication of one or more KPIs associated with the PDCP reordering window, wherein the portion of the set of SDUs is delivered based at least in part on the one or more KPIs.
Aspect 21: The method of aspect 20, further comprising: determining that the one or more KPIs fail to be satisfied based at least in part on delivery of the portion of the set of SDUs; and delivering, from the PDCP layer to the upper layer of the protocol stack, a second set of SDUs based at least in part on an expiration of the timer and a failure to satisfy the one or more KPIs.
Aspect 22: The method of any of aspects 20 through 21, further comprising: determining that the one or more KPIs fail to be satisfied based at least in part on delivery of the portion of the set of SDUs; and transmitting a report message comprising an indication that the one or more KPIs fail to be satisfied.
Aspect 23: A UE for wireless communications, comprising one or more memories storing processor-executable code, and one or more processors coupled with the one or more memories and individually or collectively operable to execute the code to cause the UE to perform a method of any of aspects 1 through 22.
Aspect 24: A UE for wireless communications, comprising at least one means for performing a method of any of aspects 1 through 22.
Aspect 25: A non-transitory computer-readable medium storing code for wireless communications, the code comprising instructions executable by one or more processors to perform a method of any of aspects 1 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that indicates one or more parameters associated with packet data convergence protocol (PDCP) reordering, wherein the one or more parameters include one or more ranges associated with at least one parameter of the one or more parameters, one or more performance parameters, or any combination thereof;
process a set of service data units via a PDCP reordering window associated with a PDCP layer of a protocol stack of the UE;
start a timer based at least in part on a count of the set of service data units that indicates that at least one service data unit is missing from the set of service data units; and
deliver, from the PDCP layer to an upper layer of the protocol stack, a portion of the set of service data units prior to an expiration of the timer, wherein the portion comprises one or more service data units that are delivered in accordance with a forwarding rule, as part of a forwarding sub-window of the PDCP reordering window, or both, and wherein the forwarding rule, the forwarding sub-window, or both, are based at least in part on the one or more parameters.

2. The UE of claim 1, wherein the one or more processors are individually or collectively further operable to execute the code to cause the UE to:
determine, based at least in part on one or more predictions associated with the set of service data units, whether to deliver the one or more service data units out-of-order with respect to other service data units of the set of service data units in accordance with the forwarding rule, wherein the one or more service data units are delivered to the upper layer in accordance with the determination.

3. The UE of claim 2, wherein the one or more predictions include a prediction of respective flows associated with each service data unit of the set of service data units, and wherein, to deliver the portion, the one or more processors are individually or collectively operable to execute the code to cause the UE to:
deliver the one or more service data units based at least in part on the prediction that indicates that the one or more service data units are associated with a same flow.

4. The UE of claim 2, wherein the one or more predictions include a prediction of one or more attributes associated with each service data unit of the set of service data units, and wherein, to deliver the portion, the one or more processors are individually or collectively operable to execute the code to cause the UE to:
deliver the one or more service data units based at least in part on the prediction that indicates that the one or more service data units are associated with a first attribute of the one or more attributes to forward the one or more service data units to the upper layer before the timer expires, a second attribute to reorder the set of service data units, or both.

5. The UE of claim 2, wherein the one or more predictions include a prediction of a priority associated with each service data unit of the set of service data units, and wherein, to deliver the portion, the one or more processors are individually or collectively operable to execute the code to cause the UE to:
deliver the one or more service data units based at least in part on the prediction that indicates that a priority of the one or more service data units indicates that the one or more service data units are to be forwarded to the upper layer before the timer expires.

6. The UE of claim 1, wherein the one or more processors are individually or collectively further operable to execute the code to cause the UE to:
determine a size of the forwarding sub-window based at least in part on a prediction of the at least one service data unit missing from the set of service data units and one or more service data units that have not yet been included in the PDCP reordering window, wherein the one or more service data units are delivered to the upper layer based at least in part on the size of the forwarding sub-window.

7. The UE of claim 6, wherein the timer continues to run after the one or more service data units are delivered to the upper layer before the timer expires in accordance with the forwarding sub-window.

8. The UE of claim 6, wherein the one or more processors are individually or collectively further operable to execute the code to cause the UE to:
determine that the size of the forwarding sub-window is at least equal to a size of the PDCP reordering window;
deliver the set of service data units associated with the PDCP reordering window; and
stop the timer.

9. The UE of claim 1, wherein the one or more processors are individually or collectively further operable to execute the code to cause the UE to:
identify one or more features associated with a machine learning model, the one or more features comprising flow detection, protocol data unit set detection, packet type detection, latency sensitivity detection, priority detection, detection of a correspondence between respective service data units, arrival latency detection, predicted failure detection, or any combination thereof, wherein the portion of the set of service data units is delivered based at least in part on the one or more features; and
predict, using the machine learning model and based at least in part on the one or more features, the one or more service data units to be delivered to the upper layer in accordance with the forwarding rule, as part of the forwarding sub-window of the PDCP reordering window, or both.

10. The UE of claim 1, wherein the one or more processors are individually or collectively further operable to execute the code to cause the UE to:
transmit a message comprising information that indicates service data units that have been delivered to the upper layer, the information comprising an indication of service data units that were delivered in order, an indication of service data units delivered out-of-order based at least in part on an expiration of the timer, an indication of service data units delivered out-of-order in accordance with the forwarding rule, an indication of service data units delivered out-of-order as part of the forwarding sub-window of the PDCP reordering window, or any combination thereof.

11. The UE of claim 1, wherein the one or more processors are individually or collectively further operable to execute the code to cause the UE to:
transmit a message comprising an indication of a reordering policy used by the UE to deliver the portion of the set of service data units to the upper layer, the reordering policy indicates one or more second parameters used for the one or more service data units delivered out-of-order with respect to other service data units of the set of service data units.

12. The UE of claim 1, wherein the one or more processors are individually or collectively further operable to execute the code to cause the UE to:
transmit a message that indicates information associated with the set of service data units, wherein the information comprises an indication of a predicted arrival time of the one or more service data units, an indication of the one or more service data units that are forwarded out-of-order with respect to other service data units of the set of service data units, an indication of the set of service data units that are delivered in-order, an indication of a value of the timer when the portion is delivered to the upper layer, an indication of a value of the count when the portion is delivered to the upper layer, an indication of respective index values of the set of service data units, an indication of a difference between a predicted arrival time of a first service data unit of the set of service data units and an actual arrival time of the first service data unit, an indication of a frequency of satisfying one or more key performance indicators, or any combination thereof.

13. The UE of claim 1, wherein the one or more processors are individually or collectively further operable to execute the code to cause the UE to:
transmit a capability message that indicates a capability of the UE to support delivery of the portion of the set of service data units, an accuracy of a machine learning model with respect to one or more predictions, or both, wherein the one or more predictions comprise one or more predicted attributes of a buffered service data unit, one or more predicted attributes of a service data unit that has not yet arrived, a predicted arrival time of respective service data units of the set of service data units, or any combination thereof.

14. The UE of claim 1, wherein the one or more processors are individually or collectively further operable to execute the code to cause the UE to:
receive a second control message that indicates a configuration of one or more reordering parameters used to reorder the set of service data units, or to deliver the portion of the set of service data units in accordance with the forwarding rule, or both, wherein delivery of the one or more service data units in accordance with the forwarding rule is based at least in part on the configuration.

15. The UE of claim 14, wherein the one or more reordering parameters comprise a first threshold duration of the timer before the one or more service data units are delivered, a second threshold duration of the timer to deliver the one or more service data units, a set of attributes used to forward the one or more service data units, a threshold quantity of service data units that are allowed to be forwarded before the timer expires, a threshold quantity of service data units per set of attributes that are allowed to be delivered out-of-order with respect to other service data units, a second timer associated with a duration, an indication of whether use of a machine learning model is allowed to deliver the set of service data units, an indication of whether the one or more service data units are to be delivered in accordance with the forwarding rule, or any combination thereof.

16. The UE of claim 1, wherein the one or more processors are individually or collectively further operable to execute the code to cause the UE to:
receive a control message that indicates a configuration of one or more reordering parameters, wherein the one or more reordering parameters are used to deliver the portion of the set of service data units as part of the forwarding sub-window of the PDCP reordering window, and wherein the one or more service data units are delivered as part of the forwarding sub-window of the PDCP reordering window based at least in part on the configuration.

17. The UE of claim 1, wherein the one or more processors are individually or collectively further operable to execute the code to cause the UE to:
receive a control message comprising an indication of one or more key performance indicators associated with the PDCP reordering window, wherein the portion of the set of service data units are delivered based at least in part on the one or more key performance indicators.

18. The UE of claim 17, wherein the one or more processors are individually or collectively further operable to execute the code to cause the UE to:
determine that the one or more key performance indicators fail to be satisfied based at least in part on delivery of the portion of the set of service data units; and
transmit a report message comprising an indication that the one or more key performance indicators fail to be satisfied.

19. A method for wireless communications at a user equipment (UE), comprising:
receiving a control message indicating one or more parameters associated with packet data convergence protocol (PDCP) reordering, wherein the one or more parameters include one or more ranges associated with at least one parameter of the one or more parameters, one or more performance parameters, or any combination thereof;
processing a set of service data units using a PDCP reordering window associated with a PDCP layer of a protocol stack of the UE;
starting a timer based at least in part on a count of the set of service data units indicating that at least one service data unit is missing from the set of service data units; and
delivering, from the PDCP layer to an upper layer of the protocol stack, a portion of the set of service data units prior to an expiration of the timer, wherein the portion comprises one or more service data units that are delivered in accordance with a forwarding rule, as part of a forwarding sub-window of the PDCP reordering window, or both, and wherein the forwarding rule, the forwarding sub-window, or both, are based at least in part on the one or more parameters.

20. A non-transitory computer-readable medium storing code for wireless communications, the code comprising instructions executable by one or more processors to:
receive a control message indicating one or more parameters associated with packet data convergence protocol (PDCP) reordering, wherein the one or more parameters include one or more ranges associated with at least one parameter of the one or more parameters, one or more performance parameters, or any combination thereof;
process a set of service data units using a PDCP reordering window associated with a PDCP layer of a protocol stack of a UE;
start a timer based at least in part on a count of the set of service data units indicating that at least one service data unit is missing from the set of service data units; and
deliver, from the PDCP layer to an upper layer of the protocol stack, a portion of the set of service data units prior to an expiration of the timer, wherein the portion comprises one or more service data units that are delivered in accordance with a forwarding rule, as part of a forwarding sub-window of the PDCP reordering window, or both, and wherein the forwarding rule, the forwarding sub-window, or both, are based at least in part on the one or more parameters.
